(19) United States
(12) Patent Application Publication
(10) Pub. No.: US 2026/0238419 A1
(43) Pub. Date: Aug. 13, 2026

(54) DEVICE AND METHOD FOR SIMULTANEOUSLY SUPPORTING BLUETOOTH LOW LATENCY AUDIO STANDARD TECHNOLOGY AND ULTRA-LOW LATENCY HID STANDARD TECHNOLOGY IN SHORT- RANGE WIRELESS COMMUNICATION SYSTEM

(71) Applicant: LG ELECTRONICS INC., Seoul (KR)

(72) Inventors: Jongmin KIM, Seoul (KR); Hyeonjae LEE, Seoul (KR); Minsoo LEE, Seoul (KR)

(73) Assignee: LG ELECTRONICS INC., Seoul (KR)

(21) Appl. No.: 19/150,844

(22) PCT Filed: Jan. 25, 2024
(86) PCT No.: PCT/KR2024/001189

§ 371 Date: Jul. 24, 2025

(30) Foreign Application Priority Data
Jan. 25, 2023 (KR) 10-2023-0009635
May 2, 2023 (KR) 10-2023-0057162

(51) Int. Cl. H04L 5/00; G06F 1/16; G06F 3/16; H04W 4/70; H04W 4/80

(52) U.S. Cl. CPC H04L 5/0048; G06F 1/16; G06F 3/16; H04W 4/70; H04W 4/80

(57) ABSTRACT

The present disclosure relates to a device and a method for simultaneously supporting a Bluetooth low latency audio standard technology and an ultra-low latency HID standard technology in a short-range wireless communication system. Particularly, the present disclosure relates to a device and a method for simultaneously supporting a Bluetooth low latency audio standard technology and an ultra-low latency HID standard technology by performing scheduling that ensures a report interval of an HID device of at least 2.5 ms while transmission of an audio is the same as related art even when Bluetooth low latency Audio and an ultra-high latency HID connection (ULL HID) are simultaneously applied.

### TECHNICAL FIELD

The present disclosure relates to a device and a method for simultaneously supporting a Bluetooth low latency audio standard technology and an ultra-low latency HID standard technology in a short-range wireless communication system. Particularly, the present disclosure relates to a device and a method for simultaneously supporting a Bluetooth low latency audio standard technology and an ultra-low latency HID standard technology by performing scheduling that ensures a report interval of an HID device of at least 2.5 ms while transmission of an audio is the same as related art even when Bluetooth low latency Audio and an ultra-high latency HID connection (ULL HID) are simultaneously applied.

### BACKGROUND ART

Based on an existing Bluetooth standard specification, Bluetooth devices are not suitable for gaming because a delay time (audio: 100 ms or more/HID device: 10 ms or more) of Bluetooth devices (e.g., an audio device, a keyboard, a mouse, and a game pad) is longer than the delay time of wired devices (audio: 30 to 40 ms/HID device: 1 ms).

In a latest Bluetooth standard specification, a technology for connecting a low latency audio (Gaming Audio Profile) and an Ultra-low Latency Human Interface Device (ULL HID) is being developed in order to be suitable for use in a game application. However, even if the latest Bluetooth standard specification is completed and the user uses a Bluetooth peripheral device, e.g., the audio device, the keyboard, the mouse, or the game pad that supports the latest Bluetooth standard specification, if a Bluetooth transmitter (e.g., a smartphone, a notebook, or a smart TV) as a Bluetooth host device actually used by the user does not support the latest Bluetooth standard specification, a low latency audio and an ultra-low latency HID connection technology may not be used.

Because typically a product exchange period of a Bluetooth transmitter (e.g., the smartphone, the notebook, or the smart TV) is longer than the exchange period of a receiver (e.g., a headset, the keyboard, the mouse, or the game pad), there is not often a case that the user may experience low latency Bluetooth as the transmitter and the receiver of the user support the latest Bluetooth standard specification in a substantially user's actual use environment.

Therefore, in order for the user to experience low latency Bluetooth by using game HID devices (the keyboard, the mouse, and the game pad) as a receiver supporting the latest Bluetooth standard specification, there is a problem in that, in reality, a self-transceiver in the form of a USB dongle supporting the latest Bluetooth standards specification must be used for a Bluetooth transmitter (e.g., the smartphone, the notebook, or the smart TV) supporting only the existing Bluetooth standard specification.

### DETAILED DESCRIPTION OF INVENTION

### Technical Problems

The present disclosure provides a device and a method for simultaneously supporting a Bluetooth low latency audio standard technology and an ultra-low latency HID standard technology in a short-range wireless communication system.

The present disclosure provides a device and a method which can be used in which a reaction speed is important as contents regarding a transmission technique and a transmission device that simultaneously support a Bluetooth low latency audio standard technology and an ultra-low latency HID standard technology.

The present disclosure provides a device and a method for simultaneously supporting a Bluetooth low latency audio standard technology and an ultra-low latency HID standard technology by performing scheduling for applying a Bluetooth low latency audio (Gaming Audio Profile) and ultra-low latency HID connection (ULL HID) standard technology to products.

The present disclosure provides a device and a method for simultaneously supporting a Bluetooth low latency audio standard technology and an ultra-low latency HID standard technology by performing scheduling that ensures a report interval of an HID device of at least 2.5 ms while transmission of an audio is the same as related art even when Bluetooth low latency Audio and an ultra-high latency HID connection (ULL HID) are simultaneously applied.

Technical objects to be achieved by the present disclosure are not limited to the aforementioned technical objects, and other technical objects not described above may be evidently understood by a person having ordinary skill in the art to which the present disclosure pertains from the following description.

### Technical Solution

According to various embodiments of the present disclosure, provided is an operation method of a first device in a short-range wireless communication system, in which the first device includes: a first processor corresponding to a host stack; a second processor corresponding to a controller stack; a memory; an input device corresponding to a user interface (UI); an output device corresponding to the UI; and a transceiver, wherein the host stack and the control stack are connected via a host controller interface (HCI), which includes: repetitively broadcasting a first signal every first time interval; repetitively transmitting a second signal to a second device, which is connected to the first device, every second time interval after a first offset from the transmission time of the first signal; and repetitively transmitting a third signal to a third device, which is connected to the first device, every third time interval after a second offset from the transmission time of the second signal, in which the first signal, the second signal, and the third signal are not simultaneously transmitted.

According to various embodiments of the present disclosure, provided is a first device in a short-range wireless communication system, which includes:
a first processor corresponding to a host stack; a second processor corresponding to a controller stack; a memory; an input device corresponding to a user interface (UI); an output device corresponding to the UI; and a transceiver, in which the host stack and the controller stack are connected by a Host Controller Interface (HCI), the memory stores instructions of performing operations based on being executed by the first processor and the second processor, in an operation method of a first device in a short-range wireless communication system, the first device includes: a first processor corresponding to a host stack; a second processor corresponding to a controller stack; a memory; an input device corresponding to a user interface (UI); an output device corresponding to the UI; and a transceiver, wherein the host stack and the control stack are connected via a host controller interface (HCI), and the operations include: repetitively broadcasting a first signal every first time interval; repetitively transmitting a second signal to a second device, which is connected to the first device, every second time interval after a first offset from the transmission time of the first signal; and repetitively transmitting a third signal to a third device, which is connected to the first device, every third time interval after a second offset from the transmission time of the second signal, and the first signal, the second signal, and the third signal are not simultaneously transmitted.

### Effect of Invention

In order to solve the above-described problems, the present disclosure can provide a device and a method for simultaneously supporting a Bluetooth low latency audio standard technology and an ultra-low latency HID standard technology in a short-range wireless communication system.

The present disclosure can provide a device and a method which can be used in which a reaction speed is important as contents regarding a transmission technique and a transmission device that simultaneously support a Bluetooth low latency audio standard technology and an ultra-low latency HID standard technology.

The present disclosure can provide a device and a method for simultaneously supporting a Bluetooth low latency audio standard technology and an ultra-low latency HID standard technology by performing scheduling for applying a Bluetooth low latency audio (Gaming Audio Profile) and ultra-low latency HID connection (ULL HID) standard technology to products.

The present disclosure can provide a device and a method for simultaneously supporting a Bluetooth low latency audio standard technology and an ultra-low latency HID standard technology by performing scheduling that ensures a report interval of an HID device of at least 2.5 ms while transmission of an audio is the same as related art even when Bluetooth low latency Audio and an ultra-high latency HID connection (ULL HID) are simultaneously applied.

### BRIEF DESCRIPTION OF THE DRAWING

The accompanying drawings, which are to provide a further understanding of the present disclosure, can provide embodiments of the present disclosure together with the detailed description. However, technical features of the present disclosure are not limited to specific drawings and features disclosed in the respective drawings may be combined with each other to constitute a new embodiment. Reference numerals in each drawing may refer to structural elements.

FIG. 1 is a schematic view illustrating an example of a wireless communication system using a Bluetooth low energy technology to which the present disclosure is applicable.

FIG. 2 illustrates an example of an internal block diagram of a device capable of implementing methods proposed by the present disclosure.

FIG. 3 illustrates an example of a Bluetooth communication architecture to which methods proposed by the present disclosure may be applied.

FIG. 4 illustrates an example of a structure of a generic attribute profile (GATT) of Bluetooth low energy.

FIG. 5 is a flowchart showing an example of a connection procedure method in Bluetooth low energy technology to which the present disclosure may be applied.

FIG. 6 illustrates an example of a configuration when using an external Bluetooth transceiver in a system according to various embodiments of the present disclosure.

FIG. 7 illustrates an example of a configuration when using an internal Bluetooth transceiver in the system according to various embodiments of the present disclosure.

FIG. 8 illustrates an example of a conventional Bluetooth broadcast audio service procedure.

FIG. 9 illustrates an example of a Bluetooth broadcast audio service procedure.

FIG. 10 illustrates an example of a broadcast audio and unicast audio simultaneous transmission technique of a Bluetooth technology in the system of the present disclosure.

FIG. 11 illustrates an example of a broadcast audio and ultra-low latency HID simultaneous transmission technique of the Bluetooth technology in the system of the present disclosure.

FIG. 12 illustrates an example of a broadcast audio and ultra-low latency HID simultaneous transmission technique of the Bluetooth technology in the system of the present disclosure.

FIG. 13 illustrates an example of a broadcast audio and ultra-low latency HID simultaneous transmission technique of the Bluetooth technology in the system of the present disclosure.

FIG. 14 illustrates an example of a unicast audio and ultra-low latency HID simultaneous transmission technique of the Bluetooth technology in the system of the present disclosure.

FIG. 15 illustrates an example of a unicast audio and ultra-low latency HID simultaneous transmission technique of the Bluetooth technology in the system of the present disclosure.

FIG. 16 illustrates an example of a unicast audio and ultra-low latency HID simultaneous transmission technique of the Bluetooth technology in the system of the present disclosure.

FIG. 17 illustrates an example of an ISO channel and ACL channel simultaneous transmission technique in the system of the present disclosure.

FIG. 18 illustrates an example of a unicast audio and ultra-low latency HID simultaneous transmission technique of the Bluetooth technology in the system of the present disclosure.

FIG. 19 illustrates an example of a unicast audio and ultra-low latency HID simultaneous transmission technique of the Bluetooth technology in the system of the present disclosure.

FIG. 20 illustrates an example of a unicast audio and ultra-low latency HID simultaneous transmission technique of the Bluetooth technology in the system of the present disclosure.

FIG. 21 illustrates an example of a unicast audio and ultra-low latency HID simultaneous transmission technique of the Bluetooth technology in the system of the present disclosure.

FIG. 22 illustrates an example of an operation process of a wireless device in a short-range wireless communication system according to various embodiments of the present disclosure.

### BEST MODE FOR CARRYING OUT THE INVENTION

In various embodiments of the present disclosure, “A or B” may mean “only A,” “only B,” or “both A and B”. In other words, “A or B” may be interpreted as “A and/or B” in various embodiments of the present disclosure. For example, in various embodiments of the present disclosure, “A, B or C” can mean “only A,” “only B,” “only C,” or “any combination of A, B, and C”.

A slash (/) or a comma used in various embodiments of the present disclosure may mean “and/or”. For example, “A/B” may mean “A and/or B”. Accordingly, “A/B” may mean “only A,” “only B,” or “both A and B”. For example, “A, B, C” may mean “A, B, or C”.

In various embodiments of the present disclosure, “at least one of A and B” may mean “only A,” “only B,” or “both A and B”. Further, in various embodiments of the present disclosure, the expression “at least one of A or B” or “at least one of A and/or B” may be interpreted the same as “at least one of A and B”.

Further, in various embodiments of the present disclosure, “at least one of A, B and C” may mean “only A,” “only B,” “only C”, or “any combination of A, B and C”. Further, in various embodiments of the present disclosure, the expression “at least one of A, B or C” or “at least one of A, B and/or C” may be interpreted the same as “at least one of A, B and C”.

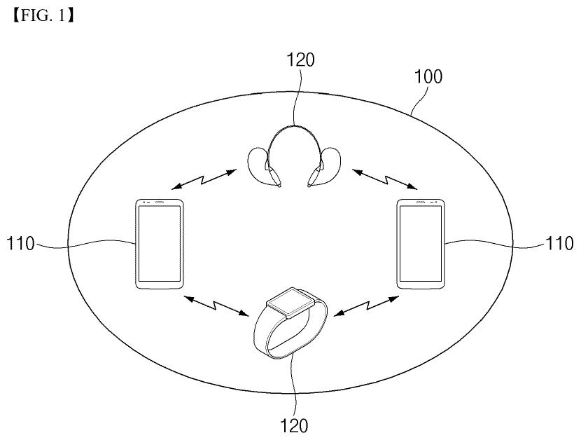

FIG. 1 is a schematic view illustrating an example of a wireless communication system using a Bluetooth low energy technology to which the present disclosure is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a slave, a server, a conductor, a host device, a gateway, a sensing device, a monitoring device, a first device, a second device, etc.

The client device 110 may be expressed as a master device, a master, a client, a member, a sensor device, a sink device, a collector, a third device, a fourth device, etc.

The server device and the client device correspond to main components of the wireless communication system and the wireless communication system may include other components other than the server device and the client device.

The server device refers to a device that receives data from the client device, communicates directly with the client device, and provides data to the client device through a response when receiving a data request from the client device.

Further, the server device sends a notice/notification message and an indication message to the client device in order to provide data information to the client device. In addition, when the server device transmits the indication message to the client device, the server device receives a confirm message corresponding to the indication message from the client device.

Further, the server device may provide the data information to a user through a display unit or receive a request input from the user through a user input interface in the process of transmitting and receiving the notice, indication, and confirm messages to and from the client device.

In addition, the server device may read data from a memory unit or write new data in the corresponding memory unit in the process of transmitting and receiving the message to and from the client device.

Further, one server device may be connected to multiple client devices and may be easily reconnected to the client devices by using bonding information.

The client device 120 refers to a device that requests the data information or data transmission to the server device.

The client device receives the data from the server device through the notice message, the indication message, etc., and when receiving the indication message from the server device, the client device sends the confirm message in response to the indication message.

Similarly, the client device may also provide information to the user through the display unit or receive an input from the user through the user input interface in the process of transmitting and receiving the messages to and from the server device.

In addition, the client device may read data from the memory unit or write new data in the corresponding memory unit in the process of transmitting and receiving the message to and from the server device.

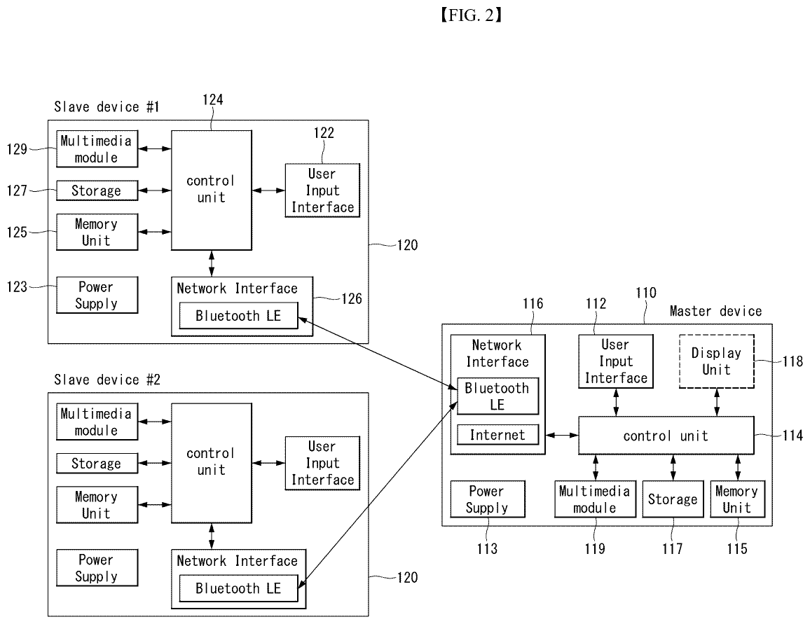

Hardware components such as the display unit, the user input interface, and the memory unit of the server device and the client device will be described in detail in FIG. 2.

Further, the wireless communication system may configure personal area networking (PAN) through Bluetooth technology. As an example, in the wireless communication system, a private piconet between the devices is established to rapidly and safely exchange files, documents, and the like.

FIG. 2 illustrates an example of an internal block diagram of a device capable of implementing methods proposed by the present disclosure.

As shown in FIG. 2, the master device 110 includes a user input interface 112, a power supply unit 113, a control unit 114, a memory unit 115), a network interface including a Bluetooth interface (Network Interface, 116), a storage (Storage, 117), an output unit (Display Unit, 118), and a multimedia module (Multi media Module, 119).

A network interface including the input unit (User Input Interface, 112), the power supply unit (Power Supply Unit, 113), the control unit (Control Unit, 114), the memory (Memory Unit, 115), and a Bluetooth interface (Bluetooth Interface) (Network Interface, 116), storage (Storage, 117), output unit (Display Unit, 118), and multimedia module (Multi media Module, 119) are functionally connected to each other to perform the method proposed in this specification.

In addition, as shown in FIG. 2, the slave devices (#1 and #2) 120 include an input unit (User Input Interface) 122, a power supply unit (Power Supply Unit) 123, a control unit (Control Unit, 124), memory (Memory Unit, 125), network interface (Network Interface, 126) including Bluetooth interface, storage (Storage, 127), output unit (Display Unit, 128), multi media module (Multi media Module, 129).

A network interface including the input unit (User Input Interface, 122), the power supply unit (Power Supply Unit, 123), the control unit (Control Unit, 124), the memory (Memory Unit, 125), and a Bluetooth interface (Bluetooth Interface) (Network Interface, 126), storage (Storage, 127), output unit (Display Unit, 128), and multimedia module (Multi media Module, 129) are functionally connected to each other to perform the method proposed in this specification.

The network interfaces 116 and 126 refer to units (or modules) capable of transmitting requests/responses, commands, notifications, instruction/confirmation messages, etc., or data between devices using Bluetooth technology.

The memories 115 and 125 are units implemented in various types of devices and refer to units in which various types of data are stored. Also, the storages 117 and 127 refer to units that perform a function similar to that of a memory.

The controllers 114 and 124 refer to a module that controls the overall operation of the master device 110 or the slave device 120, requests to transmit a message to a network interface, or controls to process a received message.

The controllers 114 and 124 may include an application-specific integrated circuit (ASIC), another chipset, a logic circuit, and/or a data processing device.

The memories 115 and 125 may include read-only memory (ROM), random access memory (RAM), flash memory, memory card, storage medium, and/or other storage devices.

The memories 115 and 125 may be inside or outside the processors 114 and 124, and may be connected to the processors 114 and 124 by various well-known means.

The output units 118 and 128 refer to modules for providing device status information and message exchange information to users through screens.

The power supply unit (power supply unit, 113, 123) refers to a module that receives external power and internal power under the control of the control unit and supplies power necessary for the operation of each component.

As discussed above, the BLE technology has a small duty cycle and can greatly reduce power consumption through a low data rate.

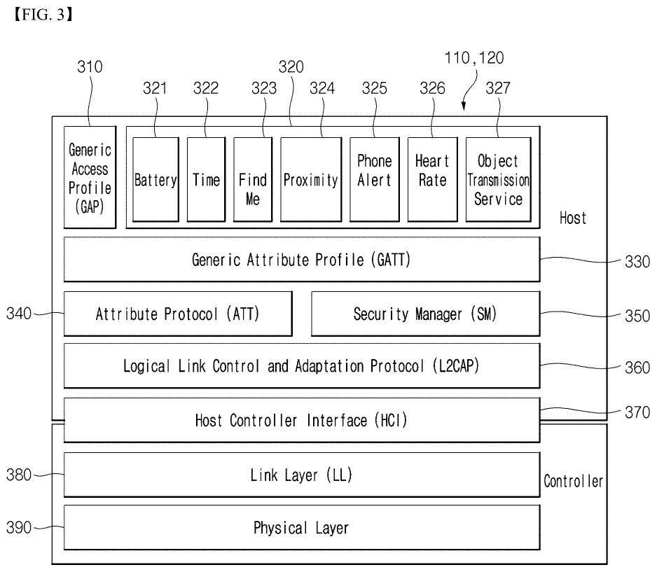

FIG. 3 illustrates an example of a Bluetooth communication architecture to which methods proposed by the present disclosure may be applied.

Specifically, FIG. 3 illustrates an example of an architecture of Bluetooth low energy (LE).

As shown in FIG. 3, the BLE structure includes a controller stack capable of processing a wireless device interface for which timing is critical and a host stack capable of processing high level data.

The controller stack may also be called a controller. In order to avoid confusion with the processor, that is, an internal element of the device described with reference to FIG. 2, however, the controller stack may be preferably used below.

First, the controller stack may be implemented using a communication module which may include a Bluetooth wireless device and a processor module which may include a processing device, such as a microprocessor.

The host stack may be implemented as part of an OS operating on the processor module or as a package instance on an OS.

In some cases, the controller stack and the host stack may operate or may be performed on the same processing device within the processor module.

The host stack includes a generic access profile (GAP) 310, GATT based profiles 320, a generic attribute profile (GATT) 330, an attribute protocol (ATT) 340, a security manager (SM) 350, and a logical link control and adaptation protocol (L2CAP) 360. The host stack is not limited to the aforementioned composition, but may include various protocols and profiles.

The host stack multiplexes various protocols and profiles provided by that Bluetooth disclosure using the L2CAP.

First, the L2CAP 360 provides one bilateral channel for sending data to according to a specific protocol or specific profile.

The L2CAP is capable of multiplexing data between upper layer protocols, segmenting or reassembling packages, and managing multicast data transmission.

BLE uses three fixed channels for respective signaling, a security manager, and an attribute protocol.

BR/EDR uses a dynamic channel and supports a protocol service multiplexer, retransmission, streaming mode.

The SM 350 authenticates a device, which is a protocol for providing a key distribution.

The ATT 340 relies on a server-client structure, which defines rules for a corresponding device for data access. Six message types are defined: Request, Response, Command, Notification, Indication, and Confirmation.
\textcircled{1} Request and Response message: the Request message is used when a client device requests specific information from a server device, and the Response message is used in response to a Request message, which is transmitted from the server device to the client device.
\textcircled{2} Command message: The Command message is transmitted from a client device to a server device in order to indicate a command for a specific operation, but the server device does not send a response to a Command message to the client device.
\textcircled{3} Notification message: A server device sends this message to a client device in order to provide notification of an event, but the client device does not send a confirmation message to the server device in response to a Notification message.
\textcircled{4} Indication and Confirm message: A server device sends this message to a client device in order to provide notification of an event. Unlike in the Notification message, the client device sends a Confirm message to the server device in response to an Indication message.

The generic access profile (GAP) is a layer newly implemented to support the BLE technology, and is used to control the selection of a role for communication between BLE devices and a multi-profile operation.

The GAP is mainly used for device discovery, connection establishment, and security. That is, the GAP defines a method for providing information to a user and also defines the following attribute types.
\textcircled{1} Service: A combination of actions related to data, and it defines the basic operation of a device.
\textcircled{2} Include: Define a relationship between services.
\textcircled{3} Characteristics: A data value used by a service
\textcircled{4} Behavior: A format that may be readable by a computer, which is defined by a Universal Unique Identifier (UUID) and a value type.

The GATT-based profiles are dependent on the GATT and are mainly applied to BLE devices. The GATT-based profiles may include Battery, Time, FindMe, Proximity, Object Delivery Service and so on. More specific descriptions of the GATT-based profiles are as follows.

Battery: A method for exchanging battery information.

Time: A method for exchanging time information.

FindMe: A method for providing an alarm service according to the distance.

Proximity: A method for exchanging battery information.

Time: A method for exchanging time information

The GATT may be used as a protocol by which to describe how the ATT is utilized at the time of composing services. For example, the GATT may be used to define how the ATT profiles are grouped together with services and to describe characteristics associated with the services.

Therefore, the GATT and the ATT describe device statuses and services, and how features are associated with each other and how they are used.

The controller stack includes a physical layer 390, a link layer 380, and a host controller interface 370.

The physical layer 390 (or a wireless transmission and reception module) sends and receives radio signals of 2.4 GHz, and uses GFSK modulation and frequency hopping utilizing 40 RF channels.

The link layer 380 sends or receives Bluetooth packets.

Furthermore, the link layer establishes a connection between devices after performing the advertising and scanning function using three advertising channels, and provides a function of exchanging a maximum of 42 bytes of data packets through 37 data channels.

The host controller interface (HCI) provides an interface between the host stack and the controller stack so that the host stack may provide commands and data to the controller stack and the controller stack may provide events and data to the host stack.

Hereinafter, the procedure of BLE is described briefly.

The BLE procedure includes a device filtering procedure, an advertising procedure, a scanning procedure, a discovering procedure, and a connecting procedure.

### Device Filtering Procedure

The device filtering procedure functions to reduce the number of devices which perform responses to requests, commands, or notification in the controller stack.

All of devices may not need to respond to received requests. Accordingly, the controller stack reduces the number of transmitted requests so that power consumption may be reduced in the BLE controller stack.

An advertising device or a scanning device may perform the device filtering procedure in order to restrict the number of devices which receive advertisement packets, scan requests, or connection requests.

In this case, the advertising device refers to a device which sends an advertisement event, that is, a device which performs advertisement, and is also called an advertiser.

A scanning device refers to a device which performs scanning, that is, a device which sends a scan request.

In the BLE disclosure, if a scanning device receives part of advertisement packets from an advertising device, the scanning device has to send a scan request to the advertising device.

If the transmission of a scan request is not required as the device filtering procedure is used, however, the scanning device may ignore advertisement packets transmitted by an advertising device.

The device filtering procedure may be used even in the connection request procedure.

If device filtering is used for the connection request procedure, the need for sending a response to a connection request may be made unnecessary by ignoring the connection request.

### Advertising Procedure

An advertising device performs an advertisement procedure to perform non-directional broadcast using the devices within the range of the advertising device.

In this case, the non-directional broadcast refers to broadcast in all directions rather than broadcast in specific directions.

Unlike the non-directional broadcast, the directional broadcast refers to broadcast in a specific direction. Non-directional broadcast is performed without involving a connection procedure between devices in a listening state (hereinafter referred to as a “listening device”).

The advertising procedure is used to establish a BLE to a nearby initiating device.

In some embodiments, the advertising procedure may be used to provide the periodic broadcast of user data to scanning devices which perform listening through an advertising channel.

In the advertising procedure, all of advertisements (or advertisement events) are broadcasted through an advertising physical channel.

An advertising device may receive a scan request from a listening device which performs a listening operation in order to obtain additional user data from the advertising device. In response to the scan request, the advertising device sends a response to the listening device which has sent the scan request through the same advertising physical channel through which the advertising device has received the scan request.

While broadcast user data sent as part of advertising packets forms dynamic data, scan response data is static for the most part.

An advertising device may receive a connection request from an initiating device through an advertising (or broadcast) physical channel. If the advertising device has used a connectable advertisement event and the initiating device has not been filtered by a filtering procedure, the advertising device stops an advertisement and enters connected mode. The advertising device may resume the advertisement after entering the connected mode.

### Scanning Procedure

A device performing a scan operation, i.e., a scanning device, performs a scanning procedure in order to listen to the non-directional broadcast of user data from advertising devices which use an advertising physical channel.

In order to request additional user data, a scanning device sends a scan request to an advertising device through an advertising physical channel. In response to the scan request, the advertising device includes additional user data requested by the scanning device in a scan response and sends the scan response to the scanning device through the advertising physical channel.

The scanning procedure may be used while a scanning device is connected to another BLE device in a BLE piconet.

If a scanning device receives a broadcast advertising event and stays in initiator mode where a connection request may be initiated, the scanning device may initiate BLE for an advertising device by sending a connection request to the advertising device through an advertising physical channel.

If a scanning device sends a connection request to an advertising device, the scanning device stops the entire scanning for additional broadcast and enters connected mode.

### Discovering Procedure

Devices capable of Bluetooth communication (hereinafter referred to as “Bluetooth devices”) perform an advertising procedure and a scanning procedure in order to discover devices around the Bluetooth devices or devices to be discovered by other devices within a given area.

The discovering procedure is performed in an asymmetric manner. A Bluetooth device searching for another Bluetooth device nearby is called a discovering device, and performs listening in order to search for devices that advertise advertisement events that may be scanned. A Bluetooth device which may be discovered and used by another device is called a discoverable device. A discoverable device actively broadcasts an advertisement event so that other devices may scan the discoverable device through an advertising (or broadcast) physical channel.

Both the discovering device and the discoverable device may already have been connected to other Bluetooth devices in a piconet.

### Connecting Procedure

A connecting procedure is asymmetric. In the connecting procedure, while a particular Bluetooth device performs an advertising procedure, other Bluetooth devices need to perform a scanning procedure.

In other words, the advertising procedure may be a primary task to be performed, and as a result, only one device may respond to an advertisement. After receiving a connectable advertisement event from an advertising device, the connecting procedure may be initiated by sending a connection request to the advertising device through an advertising (or broadcast) physical channel.

Operation statuses defined in the BLE technology, that is, an advertising state, a scanning state, an initiating state, and a connection state, are described briefly below.

### Advertising State

The link layer (LL) enters the advertising state in a command from a host (or stack). If the link layer is in the advertising state, the link layer sends advertising packet data units (PDUs) at advertisement events.

Each advertisement event includes at least one advertising PDU, and the advertising PDU is transmitted through an advertising channel index. Each advertisement event may be previously closed if the advertising PDU is transmitted through each advertising channel index, the advertising PDU is terminated, or the advertising device needs to secure the space in order to perform other functions.

### Scanning State

The link layer enters the scanning state in response to a command from a host (or stack). In the scanning state, the link layer listens to advertising channel indices.

The scanning state supports two types: passive and active scanning. The host determines a scanning type.

No separate time or advertising channel index is defined to perform scanning.

In the scanning state, the link layer listens to an advertising channel index for “scanWindow” duration. scanInterval is defined as the interval between the start points of two consecutive scan windows.

If there is no scheduling collision, the link layer has to perform listening in order to complete all of the scanIntervals of scanWindows as commanded by the host. In each scan Window, the link layer has to scan other advertising channel indices. The link layer uses all of available advertising channel indices.

In the case of passive scanning, the link layer is unable to send any packet, but only receives packets.

In the case of active scanning, the link layer performs listening to the advertising device to rely on the advertising PDU type by which additional information related to the advertising PDUs and advertising device may be requested.

### Initiating State

The link layer enters the initiating state in response to a command from a host (or stack).

In the initiating state, the link layer performs listening to advertising channel indices.

In the initiating state, the link layer listens to an advertising channel index for “scanWindow” duration.

### Connection State

The link layer enters a connection state when the device performing the connection request, i.e., the initiating device transmits CONNECT_REQ PDU to the advertising device or when the advertising device receives CONNECT_REQ PDU from the initiating device.

After entering the connections state, it is considered that the connection is created. However, it need not be considered so that the connection is established at the time of entering the connections state. An only difference between a newly created connection and the previously established connection is a link layer connection supervision timeout value.

When two devices are connected to each other, two devices play difference roles.

A link layer serving as a master is referred to as the master and a link layer serving as a slave is referred to as the slave. The master controls a timing of a connection event and the connection event refers to a time at which the master and the slave are synchronized.

A packet defined in the Bluetooth interface will be briefly described below. BLE devices use packets defined below.

### Packet Format

The link layer has only one packet format used for both an advertising channel packet and a data channel packet.

Each packet is constituted by four fields, i.e., a preamble, an access address, a PDU, and a CRC.

When one packet is transmitted in an advertising physical channel, the PDU will become an advertising channel PDU and when one packet is transmitted in a data physical channel, the PDU will become a data channel PDU.

### Advertising Channel PDU

The advertising channel PDU includes a 16 bit header and a payload of various sizes.

The PDU type field of an advertising channel included in the header supports PDU types defined in Table 1 below.

TABLE 1

| PDU | | | Permitted PHYs | | |
|---|---|---|---|---|---|
| Type | PDU Name | Channel | LE 1M | LE 2M | LE Coded |
| 0000b | ADV_IND | Primary | ◯ | | |
| | | Advertising | | | |
| 0001b | ADV_DIRECT_{—} | Primary | ◯ | | |
| | IND | Advertising | | | |
| 0010b | ADV_{—} | Primary | ◯ | | |
| | NONCONN_{—} | Advertising | | | |
| | IND | | | | |
| 0011b | SCAN_REQ | Primary | ◯ | | |
| | | Advertising | | | |
| | AUX_SCAN_{—} | Secondary | ◯ | ◯ | ◯ |
| | REQ | Advertising | | | |
| 0100b | SCAN_RSP | Primary | ◯ | | |
| | | Advertising | | | |
| 0101b | CONNECT_{—} | Primary | ◯ | | |
| | IND | Advertising | | | |
| | AUX_{—} | Secondary | ◯ | ◯ | ◯ |
| | CONNECT_{—} | Advertising | | | |
| | REQ | | | | |
| 0110b | ADV_SCAN_{—} | Primary | ◯ | | |
| | IND | Advertising | | | |

### Advertising PDU

The following advertising channel PDU types are called advertising PDUs and are used for specific events.
ADV_IND: a connectable non-directional advertisement event
ADV_DIREC_IND: a connectable directional advertisement event
ADV_NONCONN_IND: a non-connectable non-directional advertisement event
ADV_SCAN_IND: a non-directional advertisement event that may be scanned

The PDUs are transmitted by the link layer in the advertising state and are received by the link layer in the scanning state or initiating state.

### Scanning PDUs

The advertising channel PDU type below is called a scanning PDU and is used in the status described below.

SCAN_REQ: transmitted by the link layer in the scanning state and received by the link layer in the advertising state.

SCAN_RSP: transmitted by the link layer in the advertising state and received by the link layer in the scanning state.

### Initiating PDUs

The advertising channel PDU type below is called an initiating PDU.

CONNECT_REQ: transmitted by the link layer in the initiating state and received by the link layer in the advertising state.

### Data Channel PDU

The data channel PDU may have a 16-bit header and various sizes of payloads and include a message integrity check (MIC) field.

The procedure, the state, the packet format, and the like in the BLE technology, which are described above, may be applied in order to perform methods proposed by the present disclosure.

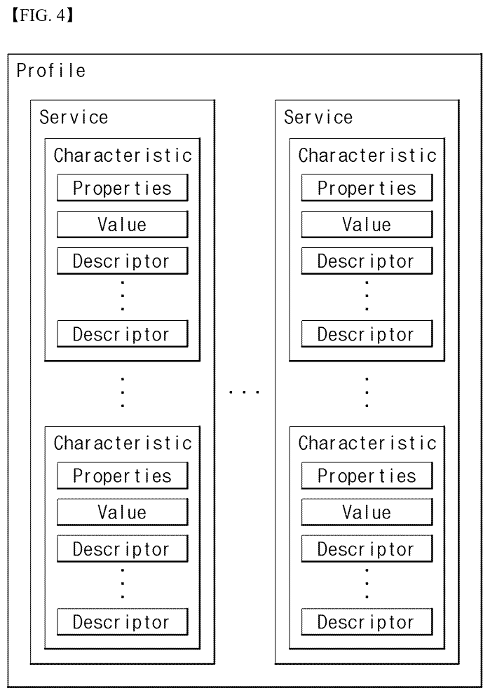

FIG. 4 illustrates an example of a structure of a generic attribute profile (GATT) of Bluetooth low energy.

Referring to FIG. 4, a structure for exchanging profile data of the Bluetooth low energy may be described.

Specifically, the generic attribute profile (GATT) is a definition of a method in which data is transmitted and received by using services and characteristics between the Bluetooth LE devices.

In general, a Peripheral device (e.g., a sensor device) serves as a GATT server and has a definition of services and characteristics.

A GATT client sends a data request to the GATT server in order to read or write the data and all transactions start at the GATT client and the response is received from the GATT server.

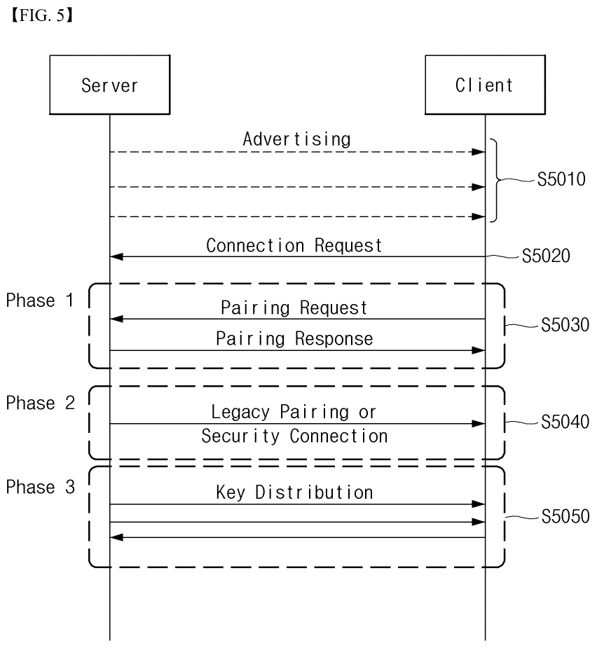

A GATT-based operation structure used in the Bluetooth LE may be based on THE profile, the service, and the characteristic, and may have a vertical structure illustrated in FIG. 5.

The profile may be constituted by one or more services and the service may be constituted by one or more characteristics or other services.

The service may serve to divide data into logical units and include one or more characteristics or other services. Each service has a 16-bit or 128-bit separator called a Universal Unique Identifier (UUID).

The characteristic is a lowest unit in the GATT-based operation structure. The characteristic includes only one datum and has a 16-bit or 128-bit UUID similar to the service.

The characteristic is defined as a value of various information and requires one attribute to contain each information. The characteristic may adopt various consecutive attributes.

The attribute is constituted by four components, which have the following meanings.
handle: Address of attribute
Type: Type of attribute
Value: Value of attribute
Permission: Access authority to attribute

FIG. 5 is a flowchart illustrating an example of a connection procedure method in Bluetooth low power energy technology to which the present disclosure may be applied.

A server transmits to a client an advertisement message through three advertising channels (S5010).

The server may be called an advertiser before connection and called as a master after the connection. As an example of the server, there may be a sensor (temperature sensor, etc.).

Further, the server may be called a scanner before the connection and called as a slave after the connection. As an example of the client, there may be a smartphone, etc.

As described above, in Bluetooth, communication is performed over a total of 40 channels through the 2.4 GHz band. Three channels among 40 channels as the advertising channels are used for exchanging sent and received for establishing the connection, which include various advertising packets.

The remaining 37 channels are used for data exchange after connection to the data channel.

The client may receive the advertisement message and thereafter, transmit the Scan Request message to the server in order to obtain additional data (e.g., a server device name, etc.).

In this case, the server transmits the Scan Response message including the additional data to the client in response to the Scan Request message.

Here, the Scan Request message and the Scan Response message are one type of advertising packet and the advertising packet may include only user data of 31 bytes or less.

Therefore, when there is data in which the size of the data is larger than 3 bytes, but overhead to transmit the data through the connection, the data is divided and sent twice by using the Scan Request message and the Scan Response message.

Next, the client transmits to the server a Connection Request message for establishing a Bluetooth connection with the server (S5020).

Therefore, a Link Layer (LL) connection is established between the server and the client.

Thereafter, the server and the client perform a security establishment procedure.

The security establishment procedure may be interpreted as security simple pairing or may be performed including the same.

That is, the security establishment procedure may be performed through Phase 1 through Phase 3.

Specifically, a pairing procedure (Phase 1) is performed between the server and the client (S5030).

In the pairing procedure, the client transmits a Pairing Request message to the server and the server transmits a Pairing Response message to the client.

Through the pairing procedure, authentication requirements and input (I)/output (O) capabilities and Key Size information are sent and received between the devices. Through the information, which key generation method is to be used in Phase 2 is determined.

Next, as Phase 2, legacy pairing or secure connections are performed between the server and the client (S5040).

In Phase 2, A 128-bit temporary key and a 128-bit short term key (STK) for performing the legacy pairing are generated.
Temporary Key: Key made for creating the STK
Short Term Key (LTK): Key value used for making encrypted connection between devices

When the secure connection is performed in Phase 2, a 128-bit long term key (LTK) is generated.
Long Term Key (LTK): Key value used even in later connection in addition to encrypted connection between the devices

Next, as Phase 3, a Key Distribution procedure is performed between the server and the client (S5050).

Therefore, the secure connection may be established and the data may be transmitted and received by establishing the encrypted link.

### General Matters Related to Isochronous Channel

With respect to an audio signal, audio streaming data or audio data may be periodically generated at an idle event interval.

The audio data is generated periodically (or at a specific time interval) according to a feature thereof. Here, the specific time interval at which the audio data is periodically generated may be expressed as idle event interval. Each audio data is transmitted at each idle event interval. Further, each audio data may be transmitted through an entire interval or a partial interval of the idle event interval. When the audio streaming data which is generated periodically or regularly is transmitted by using a BLE mechanism, an advertising and scanning procedure, a communication procedure, and a disconnection procedure should be performed whenever the generated audio data is transmitted/received. However, the audio data is generally periodically generated, and latency guarantee for audio data transmission is required regardless of a data mount of the audio data.

However, when the advertising and scanning procedure, the communication procedure, and the disconnection procedure should be performed each time newly generated audio data is transmitted, there is a problem in that latency occurs in audio data transmission.

In audio data transmission through hearing aids (HA) or headset, a data generation amount is comparatively small, so when BLE technology is utilized, higher energy efficiency may be obtained than Bluetooth BR/EDR technology, but since a data channel process of the BLE technology should perform advertising, connection, etc., every data transmission as described above, the data transmission has large overhead, and in particular, latency guarantee absolutely required for the audio data transmission may not be guaranteed.

Further, since the data channel process of the BLE technology has a purpose of transmitting isolatedly generated data only as necessary, and inducing deep sleep of a BLE device in other time domains to increase energy efficiency, it may be difficult to apply the data channel process of the BLE technology to transmission of periodically generated audio data.

### Definition of Isochronous Channel and Mechanism Related Thereto

A new channel, i.e., an isochronous channel is defined in order to transmit the periodically generated data by using the BLE technology.

The isochronous channel is a channel used for transmitting the isochronous data between devices (e.g., conductor-member) using an isochronous stream.

The isochronous data refers to data transmitted at a specific time interval, i.e., periodically or regularly.

That is, the isochronous channel may represent a channel in which periodically generated data such as audio data or voice data is transmitted and received in the BLE technology. Further, the isochronous channel may represent a channel on which data generated based on a user input of a game user's controller device is transmitted and received in a gaming scenario. The isochronous channel can be used for transmitting and receiving data to and from a single member, a set of one or more coordinated members, or multiple members. Further, the isochronous channel corresponds to a flushing channel which can be used for transmitting and receiving key data in an isochronous stream such as an audio streaming or other time domains.

### Configuration of Various Embodiments of Present Disclosure

A background for various embodiments of the present disclosure is as follows.
(1) Bluetooth devices (audio/keyboard/mouse/game pad) are not suitable for gaming because the delay time (audio: 100 ms or more/HID device: 10 ms or more) takes longer than that of wired devices (audio: 30 to 40 ms/HID device: 1 ms).
(2) In the latest Bluetooth standard, a low-delay audio (Gaming Audio Profile) and an ultra-low latency HID connection technology (ULL HID) are being developed for a game, and even when the Bluetooth standard is completed, if the transmitter does not support the Bluetooth standard for the game, the low latency audio and ultra-low latency HID connection technology may not be used.
(3) Bluetooth source devices (e.g., smartphones, notebooks, and smart TVs) have longer product exchange cycles than receiver (headset/keyboard/mouse/game pad) exchange cycles, so there are not many source devices that initially support a Bluetooth low latency technology.
(4) HID devices for the game had to use their own transceiver in the form of a USB dongle for low latency.

Proposals according to various embodiments of the present disclosure are as follows.
(1) The present disclosure can be used in which a reaction speed is important as contents regarding a transmission technique and a transmission device that simultaneously support a Bluetooth low latency audio standard technology and an ultra-low latency HID standard technology.
(2) The present disclosure provides a scheduling technique for applying Bluetooth low latency gaming audio profile and ultra-low latency (ULL) HID connection standard technology to products.
(3) The present disclosure provides a schedule technique that ensures a report interval of at least 2.5 ms of an HID device while transmission of an audio is the same as related art even when a Bluetooth low latency audio and an ultra-low latency HID connection (ULL HID) are simultaneously applied.
(4) The transmission device in the present disclosure ensures the same operation as the existing Bluetooth reception device, and is compatible with all source devices connected by USB and HDMI interfaces.
(5) The present disclosure ensures compatibility by utilizing a Bluetooth standard technology unlike conventional low latency products.

Effects of various embodiments of the present disclosure are as follows.
(1) By providing the low latency audio and the ultra-low latency HID connection technology to a game user wirelessly, it is possible to deliver a reaction rate equivalent to that of a wired scheme.
(2) The low latency audio standard technology and the ultra-low latency HID standard technology may be used by using a USB or an HDMI port in a notebook or a TV that has been used previously.

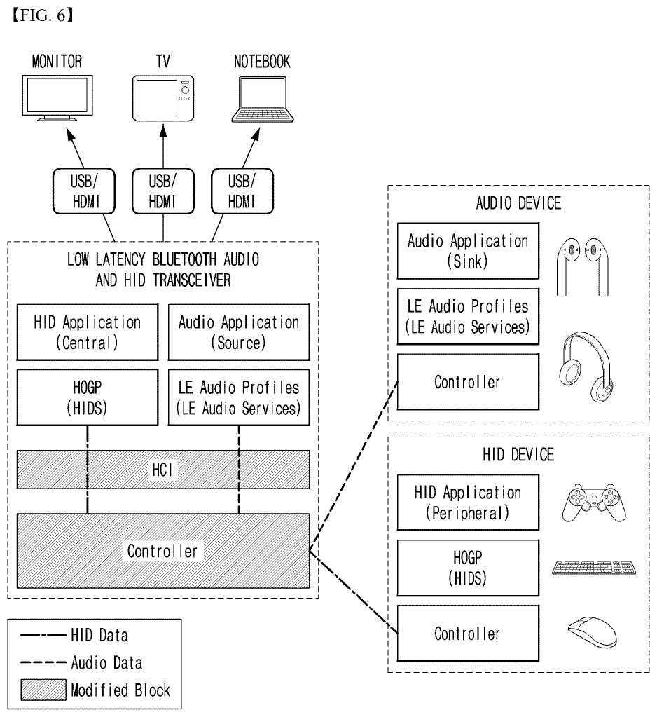

FIG. 6 illustrates an example of a configuration when using an external Bluetooth transceiver in a system according to various embodiments of the present disclosure.

Referring to FIG. 6, the low latency Bluetooth audio and transceiver includes a Human Interface Device (HID) Application (Central), a HID Over GATT Profile (HOGP) (Human Interface Device Service (HIDS)), an Audio Application (Source), Low Energy (LE) Audio Profiles (LE Audio Services), a Host Controller Interface (HCI), and a controller.

The low latency Bluetooth audio and transceiver may be connected to the monitor/TV/notebook via the USB/HDMI.

The HOGP (HIDS) transmits and receives HID data to and from the HCI and the controller. The audio profiles (LE Audio Services) transmit and receive audio data to and from the HCI and a controller.

The HCI and the controller correspond to a modified block.

The audio device corresponds to a wireless earphone, a wireless headphone, or the like that supports Bluetooth. The audio device includes an audio application (sink), an LE audio profiles (LE audio services), and a controller.

The HID device corresponds to a wireless game controller, a wireless keyboard, a wireless mouse, or the like that support Bluetooth. The HID device includes a HID Application (Peripheral), a HOGP (HIDS), and a controller.

The controller included in the low latency Bluetooth audio and transceiver transmits and receives audio data to and from the controller included in the audio device.

The controller included in the low latency Bluetooth audio and transceiver transmits and receives HID data to and from the controller included in the HID device.

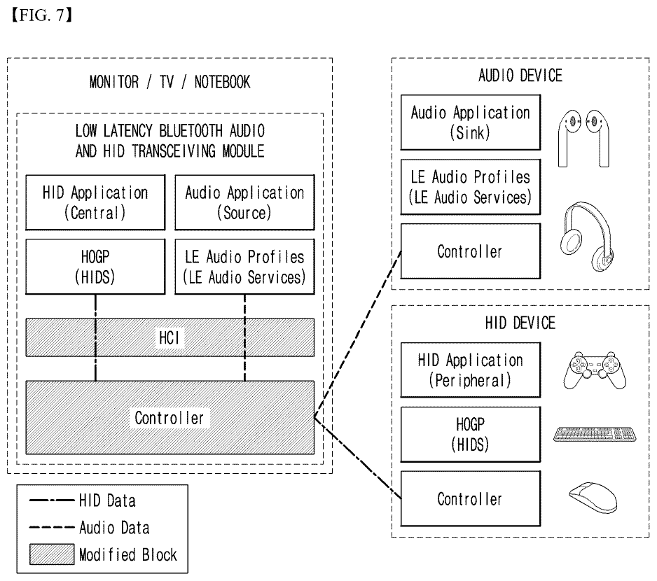

FIG. 7 illustrates an example of a configuration when using an internal Bluetooth transceiver in the system according to various embodiments of the present disclosure.

Referring to FIG. 7, a monitor/TV/notebook includes a low latency Bluetooth audio and HID transceiving module.

The low latency Bluetooth audio and HID transceiving module includes a Human Interface Device (HID) Application (Central), a HID Over GATT Profile (HOGP) (Human Interface Device Service (HIDS)), an Audio Application (Source), Low Energy (LE) Audio Profiles (LE Audio Services), a Host Controller Interface (HCI), and a Controller.

The HOGP (HIDS) transmits and receives HID data to and from the HCI and the controller. The Audio Profiles (LE Audio Services) transmit and receive audio data to and from the HCI and the controller.

The HCI and the controller correspond to a modified block.

The audio device corresponds to a wireless earphone, a wireless headphone, or the like that supports Bluetooth. Audio [symbol] Audio Application (Sink), LE Audio Profiles (LE Audio Services), Controller [symbol] .

The HID device corresponds to a wireless game controller, a wireless keyboard, a wireless mouse, or the like that support Bluetooth. The HID device includes a HID Application (Peripheral), a HOGP (HIDS), and the controller.

The controller included in the low latency Bluetooth audio and HID transceiving module transmits and receives audio Data to and from the controller included in the audio device.

The controller included in the low latency Bluetooth audio and HID transceiving module transmits and receives HID data to and from the controller included in the HID device.

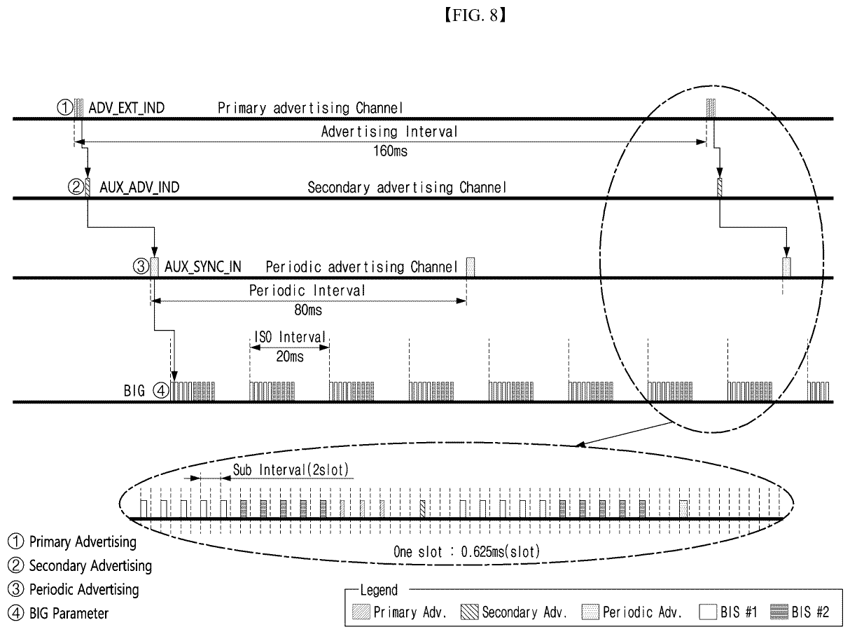

FIG. 8 illustrates an example of a conventional Bluetooth broadcast audio service procedure.

FIG. 8 illustrates a procedure in which a central device (e.g., TV) broadcasts an audio in two channels, and illustrates an example in a specification of 48 k Hz/Stereo/100 bytes.
(1) Primary advertising is performed on 37, 38, and 39 channels and transmits up to 31 byte\tilde{s}.
(1-1) Primary advertisement ADV_EXT_IND is transmitted through a primary advertising channel.
(1-2) An advertising interval from three consecutive transmissions of the primary advertisement to three consecutive transmissions of next primary advertisement corresponds to 160 ms.
(2) Periodic advertisement information is transmitted through secondary advertising.
(2-1) Secondary advertisement ADV_ADV_IND is transmitted through a secondary advertising channel.
(2-2) An advertising interval from the transmission of the secondary advertisement to transmission of next secondary advertising corresponds to 160 ms.
(3) BIG information is transmitted through periodic advertising.
(3-1) Periodic advertisement AUX_SYNC_IND is transmitted through a periodic advertising channel.
(3-2) A periodic interval from the transmission of the periodic advertisement to transmission of next periodic advertisement corresponds to 80 ms.
(4) A big parameter is performed in a state of # of BIS: 2, RTN: 4, Isochronous (ISO) interval: 20 ms, Sub-Interval: 1.25 ms (2 slots), PHY Mode: 2M PHY, and Sequential.
(4-1) After five consecutive transmissions of BIS #1, five consecutive transmissions of BIS #2 are performed. An ISO_interval from consecutive transmission of BIS #1 and consecutive transmissions of BIS #2 to consecutive transmissions of next BIS #1 and consecutive transmissions of next BIS #2 corresponds to 20 ms.
(5) Five consecutive transmissions of BIS #1, five consecutive transmissions of BIS #2, three consecutive transmissions of primary advertisement, transmission of secondary advertisement, five consecutive transmission of BIS #1, five consecutive transmission of BIS #2, three consecutive transmissions of primary advertisement, and transmission of periodic advertisement may be performed by overlapping. As a unit of a transmission time, 1 slot is 0.625 ms, and Sub_Interval corresponds to 2 slots. Five consecutive transmissions of BIS #1, five consecutive transmissions of BIS #2, and three consecutive transmissions of primary advertisement are performed at an interval of two slots, and the secondary advertisement is transmitted after four slots from the last transmission of last primary advertisement. Five consecutive transmissions of next BIS #1, five consecutive transmissions of BIS #2, and three consecutive transmissions of primary advertisement after 4 slots from the transmission of secondary advertisement are performed at an interval of 2 slots. Periodic advertisement is transmitted after 4 slots from the transmission of last primary advertisement.

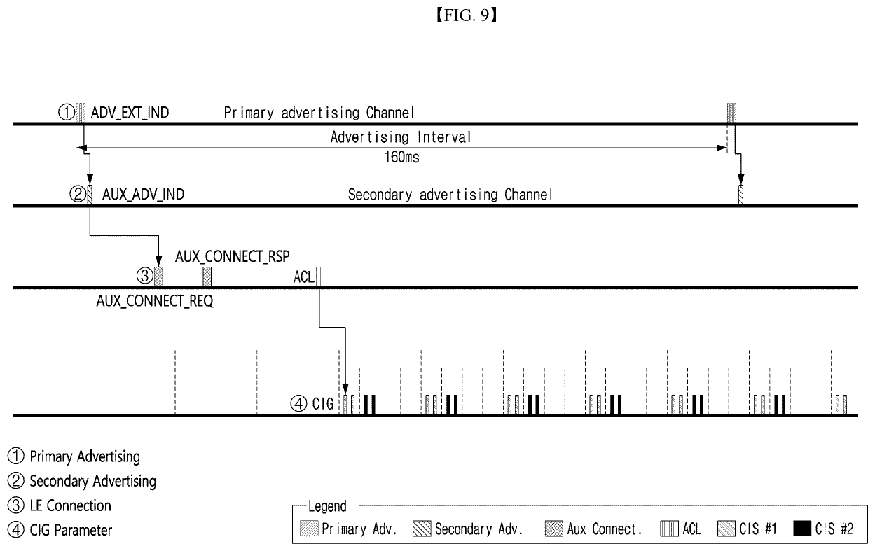

FIG. 9 illustrates an example of a Bluetooth broadcast audio service procedure.

FIG. 9 illustrates an example of a procedure of connecting the central device (e.g., TV) and one connected isochronous group (CIG).
(1) Primary advertising is performed on 37, 38, and 39 channels and transmits up to 31 byte\tilde{s}.
(1-1) Primary advertisement ADV_EXT_IND is transmitted through a primary advertising channel.
(1-2) An advertising interval from three consecutive transmissions of the primary advertisement to three consecutive transmissions of next primary advertisement corresponds to 160 ms.
(2) Periodic advertisement information is transmitted through secondary advertising.
(2-1) Secondary advertisement ADV_ADV_IND is transmitted through a secondary advertising channel.
(2-2) An advertising interval from the transmission of the secondary advertisement to transmission of next secondary advertising corresponds to 160 ms.
(3) AUX_CONNECT_REQ, AUX_ConNECT_RSP, and LE ACL are transmitted through a low energy (LE) connection.
(3-1) AUX_CONNECT_REQ is transmitted, AUX_CONNECT_RSP is transmitted, and LE ACL is transmitted.
(4) A CIG parameter is performed in a state of # of Connected Isochronous Stream (CIS): 2, ISO Interval: 10 ms, Sub-Interval: 1.25 ms (2 slots), PHY Mode: 2M PHY, and NSE: 4.
(4-1) After two consecutive transmissions of CIS #1, two consecutive transmissions of CIS #2 are performed. An interval from two consecutive transmissions of CIS #2 after two consecutive transmissions of CIS #1 to two consecutive transmissions of next CIS #2 after two consecutive transmission of next CIS #1 corresponds to 4 slots.

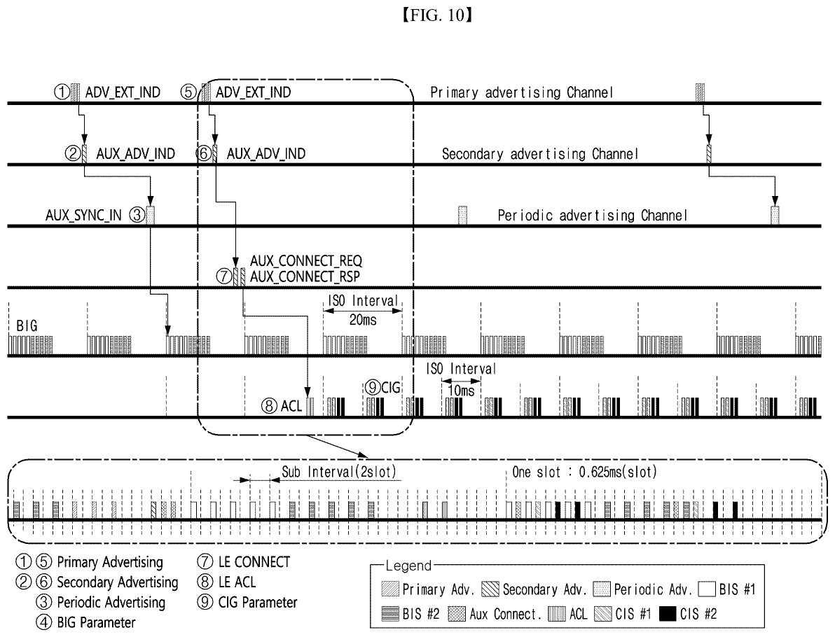

FIG. 10 illustrates an example of a broadcast audio and unicast audio simultaneous transmission technique of a Bluetooth technology in the system of the present disclosure.

FIG. 10 illustrates an example of a technique in which the transmitter simultaneously transmits a broadcast audio and a connected audio without collision with one slot offset without a receiver change.
(1) Primary advertising is performed on 37, 38, and 39 channels and transmits up to 31 byte\tilde{s}.
(1-1) Primary advertisement ADV_EXT_IND is transmitted through a primary advertising channel.
(1-2) There is an interval from three consecutive transmissions of the primary advertisement to three consecutive transmissions of next primary advertisement.
(2) Periodic advertisement information is transmitted through secondary advertising.
(2-1) Secondary advertisement ADV_ADV_IND is transmitted through a secondary
(2-2) There is the same interval as primary advertisement from the transmission of the secondary advertisement to transmission of next secondary advertising.
(3) BIG information is transmitted through periodic advertising.
(3-1) Periodic advertisement AUX_SYNC_IND is transmitted through a periodic advertising channel.
(4) A BIG parameter is performed in a state of # of Broadcast Isochronous Stream (BIS): 2/RTN: 4, ISO Interval: 20 ms, and Sub-Interval: 1.25 ms (2 slots).
(4-1) After five consecutive transmissions of BIS #1, five consecutive transmissions of BIS #2 are performed. An ISO_interval from consecutive transmission of BIS #1 and consecutive transmissions of BIS #2 to consecutive transmissions of next BIS #1 and consecutive transmissions of next BIS #2 corresponds to 20 ms.
(5) Primary advertising is performed on 37, 38, and 39 channels and transmits up to 31 byte\tilde{s}.
(5-1) Primary advertisement ADV_EXT_IND is transmitted through a primary advertising channel.
(5-2) There is an interval from three consecutive transmissions of the primary advertisement to three consecutive transmissions of next primary advertisement.
(6) Periodic advertisement information is transmitted through secondary advertising.
(6-1) Secondary advertisement ADV_ADV_IND is transmitted through a secondary
(6-2) There is the same interval as primary advertisement from the transmission of the secondary advertisement to transmission of next secondary advertising.
(7) AUX_CONNECT_REQ (Peripheral) and AUX_CONNECT_RSP (Central) are transmitted through LE CONNECT.
(7-1) Aux Connection (AUX_CONNECT_REQ (Peripheral) and AUX_CON NECT_RSP (Central)) are consecutively transmitted through LE CONNECT.
(8) Asynchronous Connection-oriented Logical Transport (ACL) is transmitted through Low Energy ACL (LE ACL).
(9) A CIG parameter is performed in a state of Sub Interval: 1.25 ms, ISO Interval: 10 ms, BN: 2, and NSE: 4.
(9-1) After two consecutive transmissions of CIS #1, two consecutive transmissions of CIS #2 are performed.
(10) According to an embodiment of the present disclosure, the transmitter may simultaneously transmit a Broadcast Audio and a Unicast Audio (Connected Audio) without collision with one slot offset without a receiver change.
(10-1) A Broadcast Audio signal corresponds to Periodic Advertisement, BIS #1, and BIS #2.
(10-2) A Unicast Audio (Connected Audio) signal corresponds to Aux Connection, ACL, CIS #1, and CIS #2.
(10-3) BIS #1 and BIS #2 may be transmitted based on Sub_Interval (2 slots).
(10-4) A length of 1 slot is 0.625 ms.
(10-5) While BIS #1 and BIS #2 are transmitted, CIS #1 and CIS #2 may be transmitted at an interval of 1 slot from BIS #1 or BIS #2.
(10-6) That is, the transmitter may simultaneously transmit the Broadcast Audio and the Unicast Audio (Connected Audio) without collision with one slot offset so that signals do not overlap with each other by setting an offset between the signals.
(10-7) The receiver may receive the Broadcast Audio signal and the Unicast Audio (Connected Audio) signal from the transmitter without any change in the device.

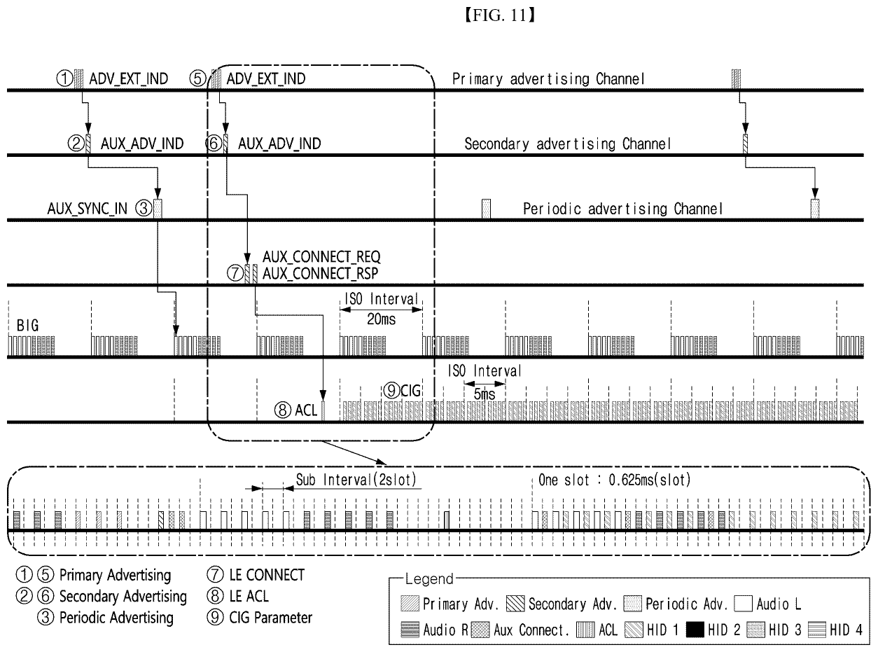

FIG. 11 illustrates an example of a broadcast audio and ultra-low latency HID simultaneous transmission technique of the Bluetooth technology in the system of the present disclosure.

FIG. 11 illustrates an example of a technique in which the transmitter simultaneously transmits a broadcast audio and an ultra-low latency HID at an interval of 1.25 ms without collision with one slot offset without a receiver change.
(1) Primary advertising is performed on 37, 38, and 39 channels and transmits up to 31 byte\tilde{s}.
(1-1) Primary advertisement ADV_EXT_IND is transmitted through a primary
(1-2) There is an interval from three consecutive transmissions of the primary advertisement to three consecutive transmissions of next primary advertisement.
(2) Periodic advertisement information is transmitted through secondary advertising.
(2-1) Secondary advertisement ADV_ADV_IND is transmitted through a secondary advertising channel.
(2-2) There is the same interval as primary advertisement from the transmission of the secondary advertisement to transmission of next secondary advertisement.
(3) Broadcast Isochronous Group (BIG) information is transmitted through periodic advertising.
(3-1) Periodic advertisement AUX_SYNC_IND is transmitted through a periodic advertising channel.
(4) A BIG parameter is performed in a state of # of BIS: 2/RTN: 4, ISO Interval: 20 ms, and Sub-Interval: 1.25 ms (2 slots).
(4-1) After five consecutive transmissions of BIS #1, five consecutive transmissions of BIS #2 are performed. An ISO_Interval from consecutive transmission of BIS #1 and consecutive transmissions of BIS #2 to consecutive transmissions of next BIS #1 and consecutive transmissions of next BIS #2 corresponds to 20 ms.
(5) Primary advertising is performed on 37, 38, and 39 channels and transmits up to 31 byte\tilde{s}.
(5-1) Primary advertisement ADV_EXT_IND is transmitted through a primary
(5-2) There is an interval from three consecutive transmissions of the primary advertisement to three consecutive transmissions of next primary advertisement.
(6) Periodic advertisement information is transmitted through secondary advertising.
(6-1) Secondary advertisement ADV_ADV_IND is transmitted through a secondary advertising channel.
(6-2) There is the same interval as primary advertisement from the transmission of the secondary advertisement to transmission of next secondary advertising.
(7) AUX_CONNECT_REQ (Peripheral) and AUX_CONNECT_RSP (Central) are transmitted through LE CONNECT.
(7-1) Aux Connection (AUX_CONNECT_REQ (Peripheral) and AUX_CON NECT_RSP (Central)) are consecutively transmitted through LE CONNECT.
(8) The ACL is transmitted via the LE ACL.
(8-1) The transmission of the LE ACL is performed in a state in which the ACL is present according to Connect Interval: 160 ms and CIS.
(9) A CIG parameter is performed in a state of Sub Interval: 1.25 ms, ISO Interval: 5 ms, BN: 1, and NSE: 4.
(9-1) After four consecutive transmissions of a CIS signal, four consecutive transmissions of the CIS signal are performed.
(9-2) An ISO_Interval from four consecutive transmissions of the CIS signal to four consecutive transmissions of a next CIS signal corresponds to 5 ms.
(10) According to an embodiment of the present disclosure, the transmitter may simultaneously transmit a Broadcast Audio and an ultra-low latency HID at an interval of 1.25 ms without collision with one slot offset without a receiver change.
(10-1) The Broadcast Audio signal corresponds to Periodic Advertisement, Audio L, and Audio R.
(10-2) The Unicast Audio (ultra-low latency HID) signal corresponds to Aux Connection, ACL, HID 1, HID 2, HID 3, and HID 4.
(10-3) Audio L and Audio R may be transmitted based on Sub_Interval (2 slots).
(10-4) A length of 1 slot is 0.625 ms.

The CIG signal (at least one of HID 1, HID 2, HID 3, and the HID 4) may be transmitted at an interval of 1 slot from Audio L and Audio R while the BIG signals (Audio L and Audio R) are consecutively transmitted.
(10-6) That is, the transmitter may simultaneously transmit the Broadcast Audio and the Unicast Audio (ultra-low latency HID) signal at an interval of 1.25 ms without collision with one slot offset so that signals do not overlap with each other by setting an offset between the signals.
(10-7) The receiver may receive the Broadcast Audio signal and the Unicast Audio (ultra-low latency HID) signal from the transmitter without any change in the device.

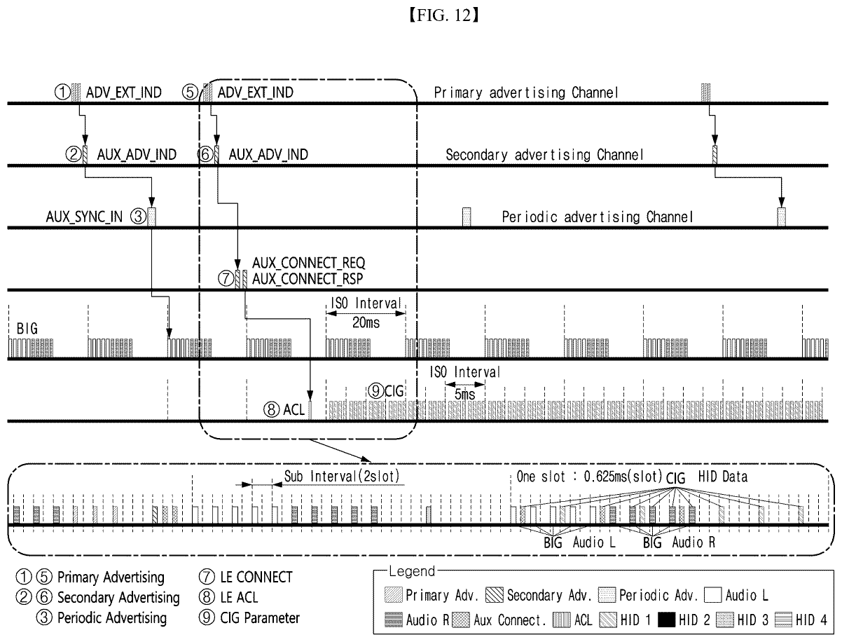

FIG. 12 illustrates an example of a broadcast audio and ultra-low latency HID simultaneous transmission technique of the Bluetooth technology in the system of the present disclosure.

FIG. 12 illustrates an example of a technique in which the transmitter simultaneously transmits a broadcast audio and an ultra-low latency HID at an interval of 2.5 ms without collision with one slot offset without a receiver change.
(1) Primary advertising is performed on 37, 38, and 39 channels and transmits up to 31 byte\tilde{s}.
(1-1) Primary advertisement ADV_EXT_IND is transmitted through a primary advertising channel.
(1-2) There is an interval from three consecutive transmissions of the primary advertisement to three consecutive transmissions of next primary advertisement.
(2) Periodic advertisement information is transmitted through secondary advertising.
(2-1) Secondary advertisement ADV_ADV_IND is transmitted through a secondary advertising channel.
(2-2) There is the same interval as primary advertisement from the transmission of the secondary advertisement to transmission of next secondary advertising.
(3) BIG information is transmitted through periodic advertising.
(3-1) Periodic advertisement AUX_SYNC_IND is transmitted through a periodic advertising channel.
(4) A BIG parameter is performed in a state of # of BIS: 2/RTN: 4, ISO Interval: 20 ms, and Sub-Interval: 1.25 ms (2 slots).
(4-1) After five consecutive transmissions of BIS #1, five consecutive transmissions of BIS #2 are performed. An ISO_Interval from consecutive transmission of BIS #1 and consecutive transmissions of BIS #2 to consecutive transmissions of next BIS #1 and consecutive transmissions of next BIS #2 corresponds to 20 ms.
(5) Primary advertising is performed on 37, 38, and 39 channels and transmits up to 31 byte\tilde{s}.
(5-1) Primary advertisement ADV_EXT_IND is transmitted through a primary advertising channel.
(5-2) There is an interval from three consecutive transmissions of the primary advertisement to three consecutive transmissions of next primary advertisement.
(6) Periodic advertisement information is transmitted through secondary advertising.
(6-1) Secondary advertisement ADV_ADV_IND is transmitted through a secondary advertising channel.
(6-2) There is the same interval as primary advertisement from the transmission of the secondary advertisement to transmission of next secondary advertisement.
(7) AUX_CONNECT_REQ (Peripheral) and AUX_CONNECT_RSP (Central) are transmitted through LE CONNECT.
(7-1) Aux Connection AUX_CONNECT_REQ (Peripheral) and AUX_CON NECT_RSP (Central)) are consecutively transmitted through LE CONNECT.
(8) The ACL is transmitted via the LE ACL.
(8-1) The transmission of the LE ACL is performed in a state in which the ACL is present according to Connect Interval: 160 ms and CIS.
(9) A CIG parameter is performed in a state of Sub Interval: 2.5 ms, ISO Interval: 5 ms, BN: 2, and NSE: 2.
(9-1) After four consecutive transmissions of a CIS signal, four consecutive transmissions of the CIS signal are performed.
(9-2) An ISO_Interval from four consecutive transmissions of the CIS signal to four consecutive transmissions of a next CIS signal corresponds to 5 ms.
(10) According to an embodiment of the present disclosure, the transmitter may simultaneously transmit a Broadcast Audio and an ultra-low latency HID at an interval of 2.5 ms without collision with one slot offset without a receiver change.
(10-1) The Broadcast Audio signal corresponds to Periodic Advertisement, Audio L, and Audio R.
(10-2) The Unicast Audio (ultra-low latency HID) signal corresponds to Aux Connection, ACL, HID 1, HID 2, HID 3, and HID 4.
(10-3) Audio L and Audio R may be transmitted based on Sub_Interval (2 slots).
(10-4) A length of 1 slot is 0.625 ms.

The CIG signal (at least one of HID 1, HID 2, HID 3, and the HID 4) may be transmitted at an interval of 1 slot from Audio L and Audio R while the BIG signals (Audio L and Audio R) are consecutively transmitted.
(10-6) That is, the transmitter may simultaneously transmit the Broadcast Audio and the Unicast Audio (ultra-low latency HID) signal at an interval of 2.5 ms without collision with one slot offset so that signals do not overlap with each other by setting an offset between the signals.
(10-7) The receiver may receive the Broadcast Audio signal and the Unicast Audio (ultra-low latency HID) signal from the transmitter without any change in the device.

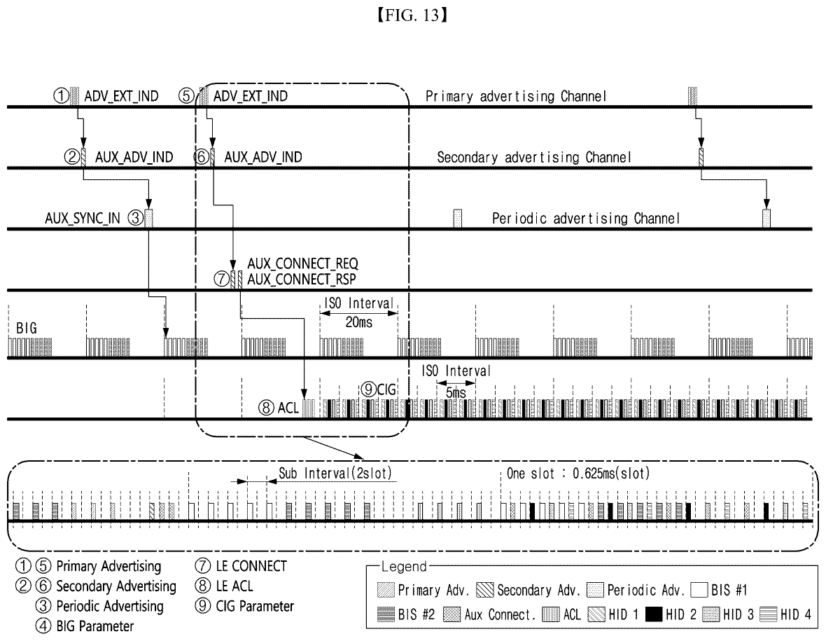

FIG. 13 illustrates an example of a broadcast audio and ultra-low latency HID simultaneous transmission technique of the Bluetooth technology in the system of the present disclosure.

FIG. 13 illustrates an example of a technique in which the transmitter simultaneously transmits a broadcast audio and multiple ultra-low latency HIDs without collision with one slot offset without a receiver change.
(1) Primary advertising is performed on 37, 38, and 39 channels and transmits up to 31 byte\tilde{s}.
(1-1) Primary advertisement ADV_EXT_IND is transmitted through a primary advertising channel.
(1-2) There is an interval from three consecutive transmissions of the primary advertisement to three consecutive transmissions of next primary advertisement.
(2) Periodic advertisement information is transmitted through secondary advertising.
(2-1) Secondary advertisement ADV_ADV_IND is transmitted through a secondary advertising channel.
(2-2) There is the same interval as primary advertisement from the transmission of the secondary advertisement to transmission of next secondary advertising.
(3) BIG information is transmitted through periodic advertising.
(3-1) Periodic advertisement AUX_SYNC_IND is transmitted through a periodic advertising channel.
(4) A BIG parameter is performed in a state of # of BIS: 2/RTN: 4, ISO Interval: 20 ms, and Sub-Interval: 1.25 ms (2 slots).
(4-1) After five consecutive transmissions of BIS #1, five consecutive transmissions of BIS #2 are performed. An ISO_Interval from consecutive transmission of BIS #1 and consecutive transmissions of BIS #2 to consecutive transmissions of next BIS #1 and consecutive transmissions of next BIS #2 corresponds to 20 ms.
(5) Primary advertising is performed on 37, 38, and 39 channels and transmits up to 31 byte\tilde{s}.
(5-1) Primary advertisement ADV_EXT_IND is transmitted through a primary advertising channel.
(5-2) There is an interval from three consecutive transmissions of the primary advertisement to three consecutive transmissions of next primary advertisement.
(6) Periodic advertisement information is transmitted through secondary advertising.
(6-1) Secondary advertisement ADV_ADV_IND is transmitted through a secondary
(6-2) There is the same interval as primary advertisement from the transmission of the secondary advertisement to transmission of next secondary advertising.
(7) AUX_CONNECT_REQ (Peripheral) and AUX_CONNECT_RSP (Central) are transmitted through LE CONNECT.
(7-1) Aux Connection AUX_CONNECT_REQ (Peripheral) and AUX_CON NECT_RSP (Central)) are consecutively transmitted through LE CONNECT.
(8) The ACL is transmitted via the LE ACL.
(8-1) The transmission of the LE ACL is performed in a state in which the ACL is present according to Connect Interval: 160 ms and CIS.
(9) A CIG parameter is performed in a state of Sub Interval: 1.25 ms, ISO Interval: 5 ms, BN: 4, and NSE: 4.
(9-1) After consecutive transmissions of four types of CIS signals, consecutive transmissions of four types of CIS signals are repeatedly performed.
(9-2) An ISO_Interval from the consecutive transmissions of the four types of CIS signals to consecutive transmissions of next four types of CIS signals corresponds to 5 ms.
(10) According to an embodiment of the present disclosure, the transmitter may simultaneously transmit a Broadcast Audio and an ultra-low latency HID at an interval of 2.5 ms without collision with one slot offset without a receiver change.
(10-1) The Broadcast Audio signal corresponds to Periodic Advertisement, BIS #1, and BIS #1.
(10-2) The Unicast Audio (ultra-low latency HID) signal corresponds to Aux Connection, ACL, HID 1, HID 2, HID 3, and HID 4.
(10-3) BIS #1 and BIS #2 may be transmitted based on Sub_Interval (2 slots).
(10-4) A length of 1 slot is 0.625 ms.

Four types of CIG signals (HID 1, HID 2, HID 3, and the HID 4) may be consecutively transmitted at an interval of 1 slot from BIS #1 and BIS #2 while the BIG signals (BIS #1 and BIS #2) are consecutively transmitted.
(10-6) That is, the transmitter may simultaneously transmit the Broadcast Audio and multiple Unicast Audio (ultra-low latency HID) signals without collision with one slot offset so that signals do not overlap with each other by setting an offset between the signals.
(10-7) The receiver may receive the Broadcast Audio signal and the Unicast Audio (ultra-low latency HID) signal from the transmitter without any change in the device.

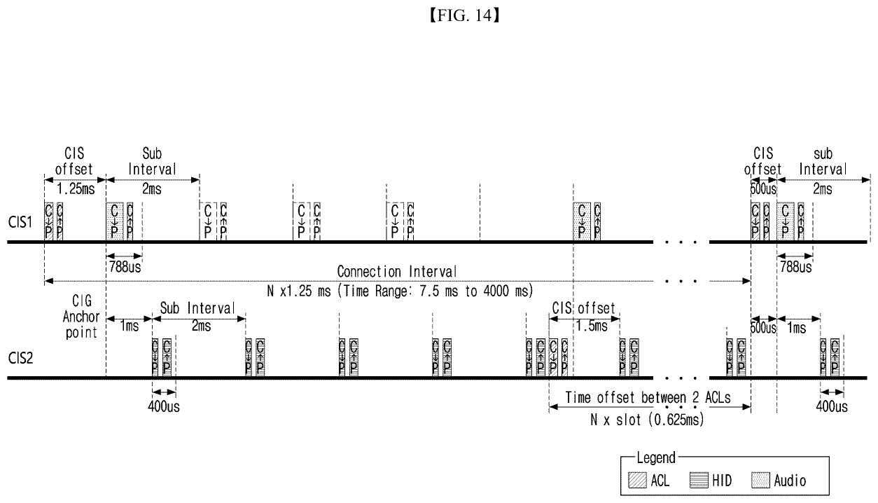

FIG. 14 illustrates an example of a unicast audio and ultra-low latency HID simultaneous transmission technique of the Bluetooth technology in the system of the present disclosure.

FIG. 14 illustrates an example of a technique in which the transmitter simultaneously transmits a unidirectional Single Mono Audio and an Ultra Low Latency Human Interface Device (ULL HID) without a receiver change. An embodiment of FIG. 14 corresponds to BAP-Audio Configuration 1.

Signal information related to the embodiment of FIG. 14 is as follows.
(1) CIG Parameter
(1-1) SDU_Interval_C_To_P=10 ms, SDU_Interval_P_To_C=2 ms
(1-2) Max_Transport_Latency_C_To_P=10 ms, Max_Transport_Latency_P_To_C=10 ms (or 2 ms)
(2) CIS 1 for Audio
(2-1) Configuration
(2-1-1) ISO Interval=10 ms, Sub Interval=2 ms
(2-1-2) CIS offset=1.25 ms (2 slot), NSE=4, BN=1, FT=1
(2-2) Duration: 788 us
(2-2-1) Central to Peripheral: 444 us (Payload 100 byte)
(2-2-2) Peripheral to Central: 44 us (Empty packet)
(2-2-3) T_IFS (150 us)+T_MSS (150 μs): 300 μs
(2-3) 48 KHz/16 bit Audio
(3) CIS 2 for HID
(3-1) Configuration
(3-1-1) ISO Interval=10 ms, Sub Interval=2 ms
(3-1-2) CIS offset=2.5 ms (4 slot), NSE=5, BN=5, FT=1
(3-2) Duration: 400 us
(3-2-1) Central to Peripheral: 44 us (Empty packet)
(3-2-2) Peripheral to Central: 56 us (Payload 8 byte)
(3-2-3) T_IFS (150 us)+T_MSS (150 μs): 300 μs

CIS1 is a signal for audio and is a broadcast signal. CIS 1 consists of a first signal transmitted from the Central device to the Peripheral device and a second signal received at the Central device from the Peripheral device.
(4-1) A CIS Offset until a first audio signal is transmitted and a second audio signal after a first ACL signal is transmitted and a second ACL signal is received is received is 1.25 ms. The transmission of the first ACL signal and the reception of the second ACL signal are performed within 500 microseconds.
(4-2) Thereafter, the transmission of the first audio signal and the reception of the second audio signal are repeated at an interval of a Sub Interval, and the Sub Interval is 2 ms. The transmission of the first audio signal and the reception of the second audio signal are performed within 788 microseconds.
(4-3) After the first ACL signal is transmitted and the second ACL signal is received, a Connection Interval elapses, and then a next first ACL signal is transmitted and a next second ACL signal is received. The Connection Interval is an integer multiple of 1.25 ms. A Time Range of the Connection Interval is between 7.5 ms and 4000 ms.
(5) CIS 2 is a signal for hid and is a unicast signal. CIS 2 consists of a first signal transmitted from the Central device to the Peripheral device and a second signal received at the Central device from the Peripheral device.
(5-1) A time point at which transmission of an initial first audio signal starts is a CIG anchor point. The CIG anchor point is 1.25 ms after a time point when the transmission of the first ACL signal starts.
(5-2) A first HID signal is transmitted and a second HID signal is received after 1 ms from the CIG anchor point. The transmission of the first HID signal and the reception of the second HID signal are performed within 400 microseconds.
(5-3) Thereafter, the transmission of the first HID signal and the reception of the second HID signal are repeated at an interval of a Sub Interval, and the Sub Interval is 2 ms.
(5-4) The first ACL signal is also transmitted and the second ACL signal is also received in CIS 2. A time offset between the transmission of the first ACL signal and the reception of the second ACL signal in CIS 2 and subsequent transmission of the first ACL signal and reception of the second ACL signal in CIS 1 is an integer multiple of the slot length (0.625 ms).
(5-5) When the transmission of the first ACL signal and the reception of the second ACL signal in CIS 1 are performed, the CIG anchor point is again defined through a transmission time point of an initial first audio signal after the transmission of the first ACL signal and the reception of the second ACL signal. The CIG anchor point is 1.25 ms after a time point when the transmission of the first ACL signal starts.
(5-6) Transmission of the first HID signal and reception of the second HID signal in CIS 2 are repeated after 1 ms from the re-defined CIS anchor point.
(6-1) That is, the transmitter may simultaneously transmit the Broadcast Audio and the Unicast Audio (ultra-low latency HID) signal at an interval of 2 ms without collision with one slot offset so that signals do not overlap with each other by setting an offset between the signals.
(6-2) The receiver may receive the Broadcast Audio signal (unidirectional Single Mono Audio) and the Unicast Audio (ultra-low latency HID) signal from the transmitter without any change in the device.

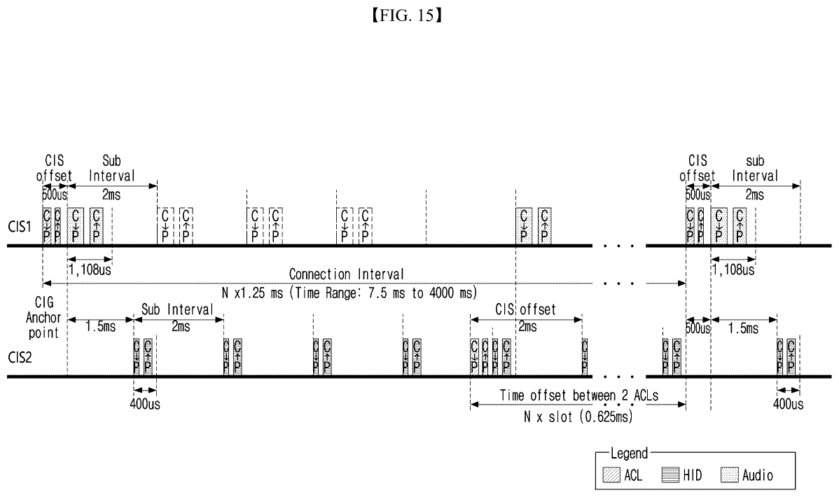

FIG. 15 illustrates an example of a unicast audio and ultra-low latency HID simultaneous transmission technique of the Bluetooth technology in the system of the present disclosure.

FIG. 15 illustrates an example of a technique in which the transmitter simultaneously transmits a bidirectional Single Mono Audio and an ultra-low latency HID (ULL HID) without a receiver change. An embodiment of FIG. 15 corresponds to BAP-Audio Configuration 3.

Signal information related to the embodiment of FIG. 15 is as follows.
(1) CIG Parameter
(1-1) SDU_Interval_C_To_P=10 ms, SDU_Interval_P_To_C=2 ms
(1-2) Max_Transport_Latency_C_To_P=10 ms, Max_Transport_Latency_P_To_C=10 ms (or 2 ms)
(2) CIS 1 for Audio
(2-1) Configuration
(2-1-1) ISO Interval=10 ms, Sub Interval=2 ms
(2-1-2) CIS offset=0.5 ms, NSE=4, BN=1, FT=1
(2-2) Duration: 1108 us
(2-2-1) Central to Peripheral: 444 us (Payload 100 byte)
(2-2-2) Peripheral to Central: 364 us (Payload 80 byte)
(2-2-3) T_IFS (150 us)+T_MSS (150 μs): 300 μs
(2-3) 48 KHz/16 bit Audio
(2-4) 32 kHz/16 bit Audio
(3) CIS 2 for HID
(3-1) Configuration
(3-1-1) ISO Interval=10 ms, Sub Interval=2 ms
(3-1-2) CIS offset=2 ms, NSE=5, BN=5, FT=1
(3-2) Duration: 400 us
(3-2-1) Central to Peripheral: 44 us (Empty packet)
(3-2-2) Peripheral to Central: 56 us (Payload 8 byte)
(3-2-3) T_IFS (150 us)+T_MSS (150 μs): 300 μs

CIS 1 is a signal for audio and is a broadcast signal. CIS 1 consists of a first signal transmitted from the Central device to the Peripheral device and a second signal received at the Central device from the Peripheral device.
(4-1) A CIS Offset until a first audio signal is transmitted and a second audio signal after a first ACL signal is transmitted and a second ACL signal is received is received is 500 microseconds. The transmission of the first ACL signal and the reception of the second ACL signal are performed within 500 microseconds.
(4-2) Thereafter, the transmission of the first audio signal and the reception of the second audio signal are repeated at an interval of a Sub Interval, and the Sub Interval is 2 ms. The transmission of the first audio signal and the reception of the second audio signal are performed within 1108 microseconds.
(4-3) After the first ACL signal is transmitted and the second ACL signal is received, a Connection Interval elapses, and then a next first ACL signal is transmitted and a next second ACL signal is received. The Connection Interval is an integer multiple of 1.25 ms. A Time Range of the Connection Interval is between 7.5 ms and 4000 ms.
(5) CIS 2 is a signal for hid and is a unicast signal. CIS 2 consists of a first signal transmitted from the Central device to the Peripheral device and a second signal received at the Central device from the Peripheral device.
(5-1) A time point at which transmission of an initial first audio signal starts is a CIG anchor point. The CIG anchor point is 500 microseconds after a time point when the transmission of the first ACL signal starts.
(5-2) A first HID signal is transmitted and a second HID signal is received after 1.5 ms from the CIG anchor point. The transmission of the first HID signal and the reception of the second HID signal are performed within 400 microseconds.
(5-3) Thereafter, the transmission of the first HID signal and the reception of the second HID signal are repeated at an interval of a Sub Interval, and the Sub Interval is 2 ms.
(5-4) The first ACL signal is also transmitted and the second ACL signal is also received in CIS 2. A time offset between the transmission of the first ACL signal and the reception of the second ACL signal in CIS 2 and subsequent transmission of the first ACL signal and reception of the second ACL signal in CIS 1 is an integer multiple of the slot length (0.625 ms).
(5-5) When the transmission of the first ACL signal and the reception of the second ACL signal in CIS 1 are performed, the CIG anchor point is again defined through a transmission time point of an initial first audio signal after the transmission of the first ACL signal and the reception of the second ACL signal. The CIG anchor point is 500 microseconds after a time point when the transmission of the first ACL signal starts.
(5-4) Transmission of the first HID signal and reception of the second HID signal in CIS 2 are repeated after 1.5 ms from the re-defined CIS anchor point.
(6-1) That is, the transmitter may simultaneously transmit the Broadcast Audio and the Unicast Audio (ultra-low latency HID) signal at an interval of 2 ms without collision with one slot offset so that signals do not overlap with each other by setting an offset between the signals.
(6-2) The receiver may receive the Broadcast Audio signal (bidirectional Single Mono Audio) and the Unicast Audio (ultra-low latency HID) signal from the transmitter without any change in the device.

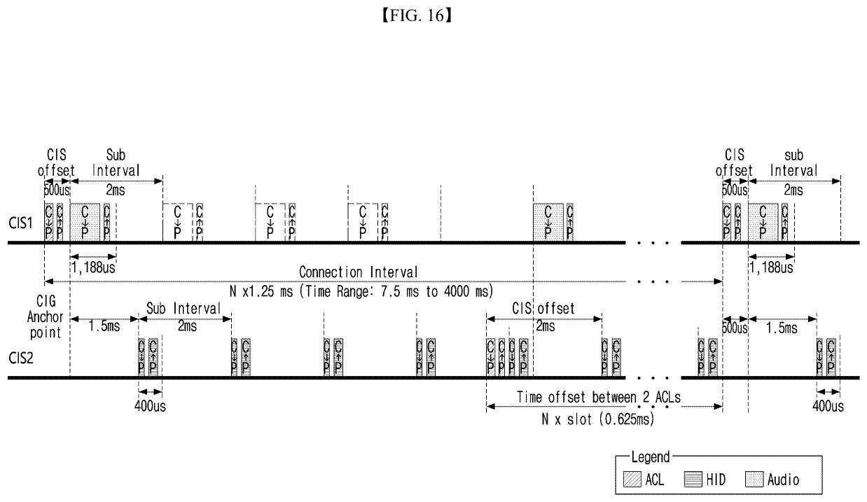

FIG. 16 illustrates an example of a unicast audio and ultra-low latency HID simultaneous transmission technique of the Bluetooth technology in the system of the present disclosure.

FIG. 16 illustrates an example of a technique in which the transmitter simultaneously transmits a unidirectional Single Stereo Audio and an ultra-low latency HID (ULL HID) without a receiver change. An embodiment of FIG. 16 corresponds to BAP-Audio Configuration 3.

Signal information related to the embodiment of FIG. 16 is as follows.
(1) CIG Parameter
(1-1) SDU_Interval_C_To_P=10 ms, SDU_Interval_P_To_C=2 ms
(1-2) Max_Transport_Latency_C_To_P=10 ms, Max_Transport_Latency_P_To_C=10 ms (or 2 ms)
(2) CIS 1 for Audio
(2-1) Configuration
(2-1-1) ISO Interval=10 ms, Sub Interval=2 ms
(2-1-2) CIS offset=0.5 ms, NSE=4, BN=1, FT=1
(2-2) Duration: 1188 us+@
(2-2-1) Central to Peripheral: 844 us+@ (Payload 200 byte+LTV header)−2 ch stream in single CIS
(2-2-2) Peripheral to Central: 44 us (Empty packet)
(2-2-3) T_IFS (150 us)+T_MSS (150 μs): 300 μs
(2-3) 48 KHz/16 bit Audio
(3) CIS 2 for HID
(3-1) Configuration
(3-1-1) ISO Interval=10 ms, Sub Interval=2 ms
(3-1-2) CIS offset=2 ms, NSE=5, BN=5, FT=1
(3-2) Duration: 400 us
(3-2-1) Central to Peripheral: 44 us (Empty packet)
(3-2-2) Peripheral to Central: 56 us (Payload 8 byte)
(3-2-3) T_IFS (150 us)+T_MSS (150 μs): 300 μs
(4) CIS 1 is a signal for audio and is a broadcast signal. CIS 1 consists of a first signal transmitted from the Central device to the Peripheral device and a second signal received at the Central device from the Peripheral device.
(4-1) A CIS Offset until a first audio signal is transmitted and a second audio signal after a first ACL signal is transmitted and a second ACL signal is received is received is 500 microseconds. The transmission of the first ACL signal and the reception of the second ACL signal are performed within 500 microseconds.
(4-2) Thereafter, the transmission of the first audio signal and the reception of the second audio signal are repeated at an interval of a Sub Interval, and the Sub Interval is 2 ms. The transmission of the first audio signal and the reception of the second audio signal are performed within 1108 microseconds.
(4-3) After the first ACL signal is transmitted and the second ACL signal is received, a Connection Interval elapses, and then a next first ACL signal is transmitted and a next second ACL signal is received. The Connection Interval is an integer multiple of 1.25 ms. A Time Range of the Connection Interval is between 7.5 ms and 4000 ms.
(5) CIS 2 is a signal for HID and is a unicast signal. CIS 2 consists of a first signal transmitted from the Central device to the Peripheral device and a second signal received at the Central device from the Peripheral device.
(5-1) A time point at which transmission of an initial first audio signal starts is a CIG anchor point. The CIG anchor point is 500 microseconds after a time point when the transmission of the first ACL signal starts.
(5-2) A first HID signal is transmitted and a second HID signal is received after 1.5 ms from the CIG anchor point. The transmission of the first HID signal and the reception of the second HID signal are performed within 400 microseconds.
(5-3) Thereafter, the transmission of the first HID signal and the reception of the second HID signal are repeated at an interval of a Sub Interval, and the Sub Interval is 2 ms.
(5-4) The first ACL signal is also transmitted and the second ACL signal is also received in CIS 2. A time offset between the transmission of the first ACL signal and the reception of the second ACL signal in CIS 2 and subsequent transmission of the first ACL signal and reception of the second ACL signal in CIS 1 is an integer multiple of the slot length (0.625 ms).
(5-5) When the transmission of the first ACL signal and the reception of the second ACL signal in CIS 1 are performed, the CIG anchor point is again defined through a transmission time point of an initial first audio signal after the transmission of the first ACL signal and the reception of the second ACL signal. The CIG anchor point is 500 microseconds after a time point when the transmission of the first ACL signal starts.
(5-4) Transmission of the first HID signal and reception of the second HID signal in CIS 2 are repeated after 1.5 ms from the re-defined CIS anchor point.
(6-1) That is, the transmitter may simultaneously transmit the Broadcast Audio and the Unicast Audio (ultra-low latency HID) signal at an interval of 2 ms without collision with one slot offset so that signals do not overlap with each other by setting an offset between the signals.
(6-2) The receiver may receive the Broadcast Audio signal (unidirectional Single Stereo Audio) and the Unicast Audio (ultra-low latency HID) signal from the transmitter without any change in the device.

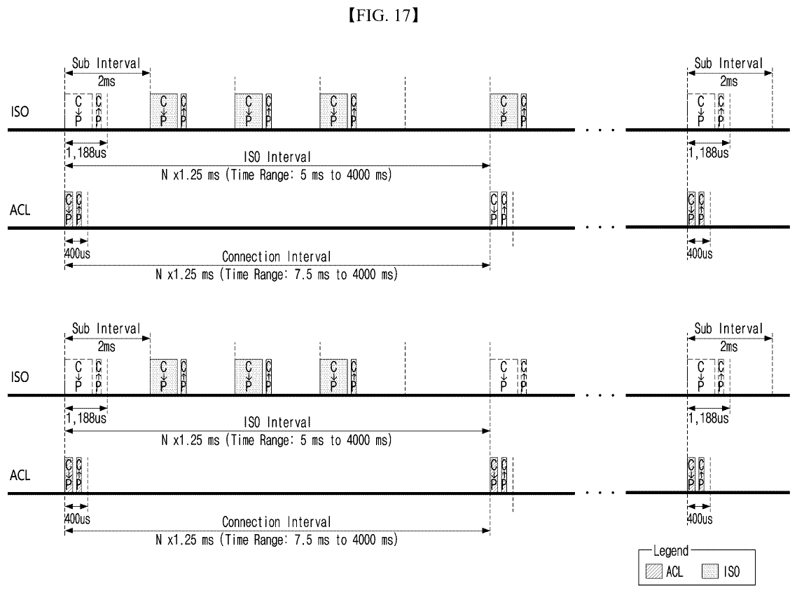

FIG. 17 illustrates an example of an ISO channel and ACL channel simultaneous transmission technique in the system of the present disclosure.

In an upper embodiment and a lower embodiment of FIG. 17, an example is shown in a technique in which an interval between an ISO channel and an ACL channel is set to a value other than a common multiple, and a priority is set when a collision occurs, and transmitted to one channel of both channels.
(1) The upper embodiment of FIG. 17 shows an example in a technique (ISO and ACL are scheduled alternately) in which a priority value of the channel is enabled to be changed so that a schedule priority is changed according to a variable algorithm.
(1-1) ISO consists of a first signal transmitted from the Central device to the Peripheral device and a second signal received at the Central device from the Peripheral device.
(1-1-1) After a first ISO signal is transmitted and a second ISO signal is received, transmission of a next first ISO signal and reception of a next second ISO signal are repeated at an interval of Sub Interval, and the Sub Interval is 2 ms. The transmission of the first ISO signal and the reception of the ISO signal are performed within 1108 microseconds.
(1-1-2) The transmission of the first ISO signal and the reception of the second ISO signal are repeated during an ISO Interval. The ISO Interval is an integer multiple of 1.25 ms. A Time Range of the ISO Interval is between 5 ms and 4000 ms.
(1-2) ACL consists of a first signal transmitted from the Central device to the Peripheral device and a second signal received at the Central device from the Peripheral device.
(1-2-1) Transmission of a first ACL signal and reception of a second ACL signal are performed within 400 microseconds.
(1-2-2) After the first ACL signal is transmitted and the second ACL signal is received, transmission of a next first ACL signal and reception of a next second ACL signal are repeated at an interval of Connection Interval, and the Connection Interval is an integer multiple of 1.25 ms. A Time Range of the Connection Interval is between 7.5 ms and 4000 ms.
(1-3) When a collision occurs between transmission and reception of the ISO and transmission and reception of the ACL, the priority of the schedule may be alternated between the ISO and the ACL.
(1-3-1) When a first collision occurs between transmission and reception of the ISO and transmission and reception of the ACL, a schedule priority is given to the ACL signal, and the transmission and reception of the ACL are performed without transmission and reception of the ISO. (1-3-1) When a second collision occurs between the transmission and reception of the ISO and the transmission and reception of the ACL, the schedule priority is given to the ISO signal, and the transmission and reception of the ISO are performed without transmission and reception of the ACL.
(1-3-2) The transmitter may transmit the ISO signal and the ACL signal simultaneously without collision, while alternating the priority of the schedule between the signals between the ISO and the ACL.
(1-3-3) The receiver may receive the ISO signal and the ACL signal from the transmitter without any change in the device.
(2) The lower embodiment of FIG. 17 shows an example in a technique in which a channel with a low Priority is not scheduled when two channels need to be simultaneously transmitted when one channel always has a high priority (an example is shown in a technique in which only the ACL is scheduled).
(2-1) ISO consists of a first signal transmitted from the Central device to the Peripheral device and a second signal received at the Central device from the Peripheral device.
(2-1-1) After a first ISO signal is transmitted and a second ISO signal is received, transmission of a next first ISO signal and reception of a next second ISO signal are repeated at an interval of a Sub Interval, and the Sub Interval is 2 ms. The transmission of the first ISO signal and the reception of the ISO signal are performed within 1108 microseconds.
(2-1-2) The transmission of the first ISO signal and the reception of the second ISO signal are repeated during ISO Interval. The ISO Interval is an integer multiple of 1.25 ms. A Time Range of the ISO Interval is between 5 ms and 4000 ms.
(2-2) ACL consists of a first signal transmitted from the Central device to the Peripheral device and a second signal received at the Central device from the Peripheral device.
(2-2-1) Transmission of a first ACL signal and reception of a second ISO signal are performed within 400 microseconds.
(2-2-2) After the first ACL signal is transmitted and the second ACL signal is received, transmission of a next first ACL signal and reception of a next second ACL signal are repeated at an interval of a Connection Interval, and the Connection Interval is an integer multiple of 1.25 ms. A Time Range of the Connection Interval is between 7.5 ms and 4000 ms.
(2-3) When a collision occurs between transmission and reception of the ISO and transmission and reception of the ACL, the priority of the schedule may be given to one of the ISO and the ACL. For example, a higher schedule priority may be configured to be always given to the ACL.
(2-3-1) When a collision occurs between the transmission and reception of the ISO and the transmission and reception of the ACL, the schedule priority is given to the ACL signal, and the transmission and reception of the ACL are performed without the transmission and reception of the ISO.
(2-3-2) The transmitter may transmit the ISO signal and the ACL signal simultaneously without collision, while giving the priority of the schedule between the signals to the ACL.
(2-3-3) The receiver may receive the ISO signal and the ACL signal from the transmitter without any change in the device.

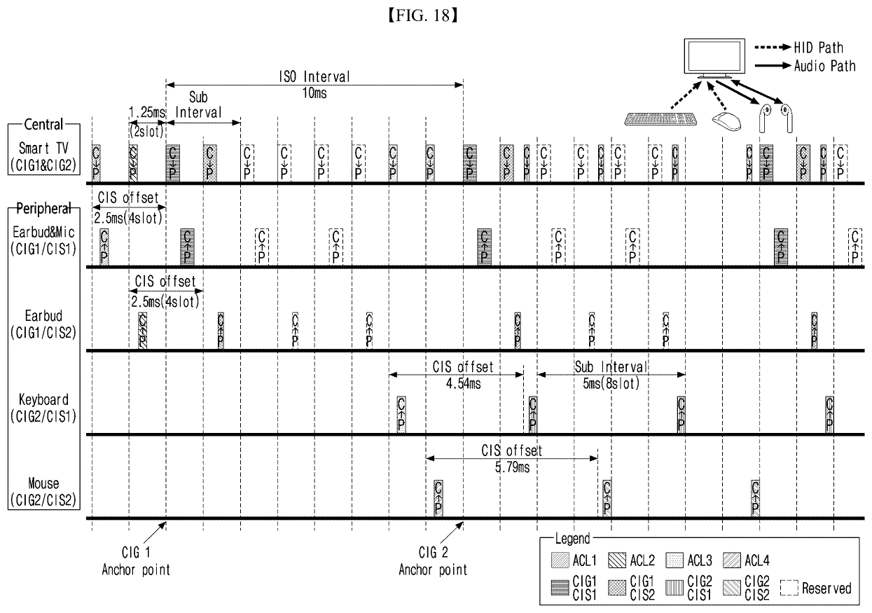

FIG. 18 illustrates an example of a unicast audio and ultra-low latency HID simultaneous transmission technique of the Bluetooth technology in the system of the present disclosure.
(1) An embodiment of FIG. 18 is a case where Unicast Audio and ultra-low latency HID of Bluetooth technology are transmitted at the same time, and may correspond to, for example, a case where an earbud, a keyboard, and a mouse that are enabled to be transmitted and received are used at the same time.
(1-1) Specifically, the embodiment of FIG. 18 corresponds to a technique in which the transmitter simultaneously transmits one bidirectional Mono Audio, one unidirectional Mono Audio, and two ULL HIDs.
(1-2) In the embodiment of FIG. 18, the transmitter separately transmits Audio and HID by CIG.
(1-3) In the embodiment of FIG. 18, the transmitter selects an inter-CIG offset as a multiple of the ISO Interval.
(1-4) In the embodiment of FIG. 18, the transmitter leaves a last interval of Audio transmission empty for the ACL.
(1-5) In the embodiment of FIG. 18, the transmitter (Central Device) may correspond to a smart TV. The receiver (Peripheral Device) may correspond to an earbud & microphone (bidirectional Mono Audio), the earbud (unidirectional Mono Audio), the keyboard (ULL HID), and the mouse (ULL HID).
(2) The transmitter (Central Device) transmits and receives signals to and from a plurality of receivers (Peripheral Devices).
(2-1) Signals transmitted and received between the transmitter (Central Device) and the plurality of receivers (Peripheral Devices) include a first signal transmitted from the Central device to the Peripheral device and a second signal received from the Peripheral device to the Central device.
(2-2) The transmitter (Central Device) sets an offset to the Audio signal and the HID signal so as to transmit the signals so as not to overlap with each other, so that various receivers may receive signals corresponding to themselves without any problem.
(2-3) The transmitter (Central Device) consecutively transmits a first ACL1 signal, a first ACL2 signal, a first first CIG1 CIS1 signal, and a first first CIG1 CIS2 signal at an interval of 2 slots (1.25 ms). Thereafter, the transmitter (Central Device) empties 8 slots (5 ms) and does not perform transmission.
(2-3-1) A time point at which a transmission of a first first CIG1 CIS2 signal starts corresponds to a CIG1 anchor point. A time point after 10 ms (ISO Interval) from the CIG1 anchor point corresponds to a CIG2 anchor point.
(2-3-2) After 12 slots from the CIG1 anchor point, the transmitter (Central Device) consecutively transmits a first ACL3 signal, a first ACL4 signal, a second first CIG1 CIS1 signal, and a second first CIG1 CIS2 signal at an interval of 2 slots. The transmitter (Central Device) repeats transmission of the first CIG1 CIS1 signal and transmission of the CIG1 CIS2 signal at an interval of 10 ms (ISO Interval).
(2-3-3) After one slot from the start time point of transmission of the first CIG1 CIS2 signal, the transmitter (Central Device) consecutively transmits the second first CIG2 CIS1 signal, the second first CIG2 CIS2 signal, the first CIG2 CIS1 signal, and the first CIG2 CIS2 signal at an interval of 4 slots. After one slot from the start time point of the transmission of the second first CIG2 CIS2 signal, the transmitter (Central Device) consecutively transmits the first CIG1 CIS1 signal and the first CIG1 CIS2 signal at an interval of 2 slots. After one slot from the start time point of the transmission of the first CIG1 CIS2 signal, the transmitter (Central Device) transmits the first CIG2 CIS1 signal.
(2-3-4) The transmitter (Central Device) alternately repeats the transmission of the first CIG2 CIS1 signal and the transmission of the second CIG2 CIS2 signal at an interval of 4 slots.
(2-3-5) The transmitter (Central Device) consecutively transmits the first CIG2 CIS1 signal at an interval of 8 slots.
(2-3-6) The transmitter (Central Device) consecutively transmits the first CIG2 CIS2 signal at an interval of 8 slots.
(3) The receiver (Peripheral Device) receives the signal transmitted from the transmitter, and transmits a response signal thereto to the transmitter.
(3-1) An earbud & microphone (bidirectional Mono Audio) corresponds to bidirectional Mono Audio. The earbud & microphone (bidirectional Mono Audio) consecutively receives a first ACL1 signal and a first CIG1 CIS1 signal from the transmitter (Central Device) at an interval of a CIS offset. The CIS offset corresponds to 2.5 ms (4 slots).
(3-1-1) The earbud & microphone (bidirectional Mono Audio) consecutively receives the first CIG1 CIS1 signal from the transmitter (Central Device) at an interval of an ISO Interval. The ISO Interval corresponds to 10 ms.
(3-1-2) The earbud & microphone (bidirectional Mono Audio) transmits a second ACL1 signal to the transmitter (Central Device) in response to the first ACL1 signal.
(3-1-3) The earbud & microphone (bidirectional Mono Audio) transmits a second CIG1 CIS1 signal to the transmitter (Central Device) in response to the first CIG1 CIS1 signal.
(3-2) The earbud & microphone (unidirectional Mono Audio) corresponds to the unidirectional Mono Audio. The earbud & microphone (unidirectional Mono Audio) consecutively receives a first ACL2 signal and the first CIG1 CIS1 signal from the transmitter (Central Device) at an interval of a CIS offset. The CIS offset corresponds to 2.5 ms (4 slots).
(3-2-1) The earbud (unidirectional Mono Audio) consecutively receives the first CIG1 CIS2 signal from the transmitter (Central Device) at an interval of an ISO Interval. The ISO Interval corresponds to 10 ms.
(3-2-2) The earbud (unidirectional Mono Audio) transmits a second ACL2 signal to the transmitter (Central Device) in response to the first ACL2 signal.
(3-2-3) The earbud (unidirectional Mono Audio) transmits a second CIG1 CIS2 signal to the transmitter (Central Device) in response to the first CIG1 CIS2 signal.
(3-3) The keyboard (ULL HID) corresponds to the ULL HID. The keyboard (ULL HID) consecutively receives a first ACL3 signal and a first CIG2 CIS1 signal from the transmitter (Central Device) at an interval of a CIS offset. The CIS offset corresponds to 4.54 ms.
(3-3-1) The keyboard (ULL HID) consecutively receives the first CIG2 CIS1 signal from the transmitter (Central Device) at an interval of a Sub Interval. The Sub Interval corresponds to 5 ms (8 slots).
(3-3-2) The keyboard (ULL HID) transmits a second ACL3 signal to the transmitter (Central Device) in response to the first ACL3 signal.
(3-3-3) The keyboard (ULL HID) transmits a second CIG2 CIS1 signal to the transmitter (Central Device) in response to the first CIG2 CIS1 signal.
(3-4) The mouse (ULL HID) corresponds to the ULL HID. The mouse (ULL HID) consecutively receives a first ACL4 signal and a first CIG2 CIS2 signal from the transmitter (Central Device) at an interval of a CIS offset. The CIS offset corresponds to 5.79 ms.
(3-4-1) The mouse (ULL HID) consecutively receives the first CIG2 CIS2 signal from the transmitter (Central Device) at an interval of a Sub Interval. The Sub Interval corresponds to 5 ms (8 slots).
(3-4-2) The mouse (ULL HID) transmits a second ACL4 signal to the transmitter (Central Device) in response to the first ACL4 signal.
(3-4-3) The mouse (ULL HID) transmits a second CIG2 CIS2 signal to the transmitter (Central Device) in response to the first CIG2 CIS2 signal.
(4-1) That is, the transmitter may simultaneously transmit an Audio signal and a ULL HID signal without collision with an offset so that signals do not overlap with each other by setting an offset between the signals.
(4-2) The receiver may receive the Audio signal and the ULL HID signal from the transmitter without any change in the device.

Signal information related to the embodiment of FIG. 18 is as follows.
(1) CIG1 Parameter
(1-1) SDU_Interval_C_To_P=10 ms, SDU_Interval_P_To_C=10 ms
(1-2) Max_Transport_Latency_C_To_P=Depend on reliability
(1-3) CIS1 for Earbud w/Mic
(1-3-1) Configuration
(1-3-1-1) ISO Interval=10 ms, Sub Interval=2.5 ms
(1-3-1-2) CIS offset=2.5 ms, NSE-3, BN=1, FT=1~4
(1-3-2) Duration: 1108 us
(1-3-2-1) Central to Peripheral: 444 us (Payload 100 byte)
(1-3-2-2) Peripheral to Central: 364 us (Payload 80 byte)
(1-3-2-3) T_IFS (150 us)+T_MSS (150 μs): 300 μs
(1-3-3-1) 48 KHz/16 bit Audio
(1-3-3-2) 32 kHz/16 bit Audio
(1-4) CIS2 for Earbud w/o Mic
(1-4-1) Configuration
(1-4-1-1) ISO Interval=10 ms, Sub Interval=2.5 ms
(1-4-1-2) CIS offset=2.5 ms, NSE=3, BN=1, FT=1~4
(1-4-2) Duration: 788 us
(1-4-2-1) Central to Peripheral: 444 us (Payload 100 byte)
(1-4-2-2) Peripheral to Central: 44 us (Empty packet)
(1-4-2-3) T_IFS (150 us)+T_MSS (150 μs): 300 μs
(1-4-3-1) Depend on channel quality
(1-4-3-2) 48 KHz/16 bit Audio
(2) CIG2 Parameter
(2-1) SDU_Interval_C_To_P=5 ms, SDU_Interval_P_To_C=5 ms
(2-2) Max_Transport_Latency_C_To_P=10 ms
(2-3) CIS1 for Keyboard
(2-3-1) Configuration
(2-3-1-1) ISO Interval=10 ms, Sub Interval=5 ms
(2-3-1-2) CIS offset=4.54 ms, NSE=2, BN=2, FT=1
(2-3-2) Duration: 460 us
(2-3-2-1) Central to Peripheral: 44 us (Empty packet)
(2-3-2-2) Peripheral to Central: 116 us (Payload 14 byte)
(2-3-2-3) T_IFS (150 us)+T_MSS (150 μs): 300 μs (2-4) CIS2 for Mouse
(2-4-1) Configuration
(2-4-1-1) ISO Interval=10 ms, Sub Interval=5 ms
(2-4-1-2) CIS offset=5.79 ms, NSE=2, BN=2, FT=1
(2-4-2) Duration: 460 us
(2-4-2-1) Central to Peripheral: 44 us (Empty packet)
(2-4-2-2) Peripheral to Central: 120 us (Payload 14 byte)
(2-4-2-3) T_IFS (150 us)+T_MSS (150 μs): 300 μs

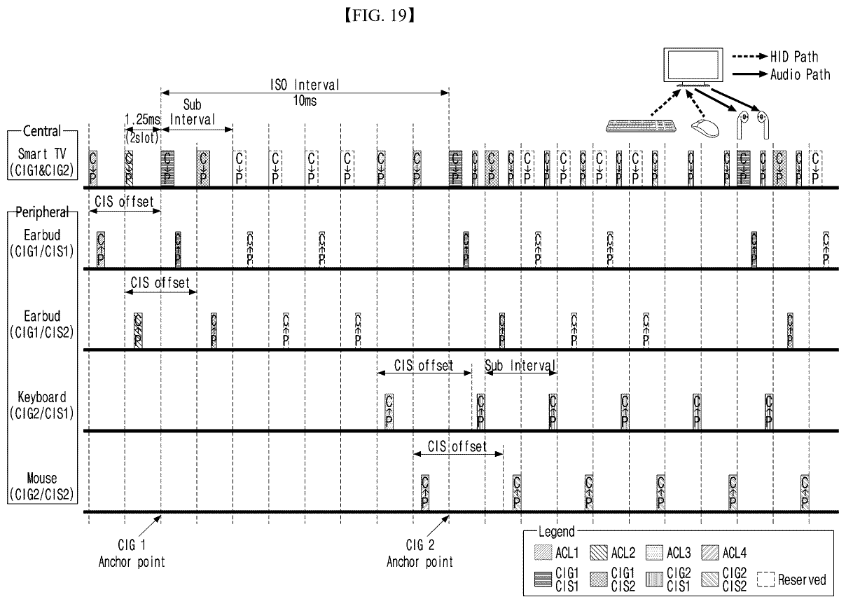

FIG. 19 illustrates an example of a unicast audio and ultra-low latency HID simultaneous transmission technique of the Bluetooth technology in the system of the present disclosure.
(1) An embodiment of FIG. 19 is a case where Unicast Audio and ultra-low latency HID of Bluetooth technology are transmitted at the same time, and may correspond to, for example, a case where an earbud, a keyboard, and a mouse that are enabled to be transmitted and received are used at the same time.
(1-1) Specifically, the embodiment of FIG. 19 corresponds to a technique in which the transmitter simultaneously transmits two unidirectional Mono Audios and two ULL HIDs.
(1-2) In the embodiment of FIG. 19, the transmitter separately transmits Audio and HID by CIG.
(1-3) In the embodiment of FIG. 19, the transmitter selects an inter-CIG offset as a multiple of the ISO Interval.
(1-4) In the embodiment of FIG. 19, the transmitter leaves a last interval of Audio transmission empty for the ACL.
(1-5) In the embodiment of FIG. 19, the transmitter (Central Device) may correspond to a smart TV. The receiver (Peripheral Device) may correspond to a first earbud (unidirectional Mono Audio), a second earbud (unidirectional Mono Audio), the keyboard (ULL HID), and the mouse (ULL HID).
(2) The transmitter (Central Device) transmits and receives signals to and from a plurality of receivers (Peripheral Devices).
(2-1) Signals transmitted and received between the transmitter (Central Device) and the plurality of receivers (Peripheral Devices) include a first signal transmitted from the Central device to the Peripheral device and a second signal received from the Peripheral device to the Central device.
(2-2) The transmitter (Central Device) sets an offset to the Audio signal and the HID signal so as to transmit the signals so as not to overlap with each other, so that various receivers may receive signals corresponding to themselves without any problem.
(2-3) The transmitter (Central Device) consecutively transmits a first ACL1 signal, a first ACL2 signal, a first first CIG1 CIS1 signal, and a first first CIG1 CIS2 signal at an interval of 2 slots (1.25 ms). Thereafter, the transmitter (Central Device) empties 8 slots (5 ms) and does not perform transmission.
(2-3-1) A time point at which a first transmission of a first CIG1 CIS2 signal starts corresponds to a CIG1 anchor point. A time point after 10 ms (ISO Interval) from the CIG1 anchor point corresponds to a CIG2 anchor point.
(2-3-2) After 12 slots from the CIG1 anchor point, the transmitter (Central Device) consecutively transmits the first ACL3 signal and the first ACL4 signal at an interval of 2 slots.
(2-3-3) From the CIG2 anchor point, the transmitter (Central Device) consecutively transmits a second first CIG1 CIS1 signal and a second first CIG1 CIS2 signal at an interval of 2 slots. Thereafter, the transmitter (Central Device) repeats transmission of the first CIG1 CIS1 signal and transmission of the CIG1 CIS2 signal at an interval of 10 ms (ISO Interval).
(2-3-4) After 1 slot from the CIG2 anchor point, the transmitter (Central Device) alternately repeats the transmission of the first CIG2 CIS1 signal and the transmission of the first CIG2 CIS2 signal at an interval of 2 slots.
(2-3-5) The transmitter (Central Device) consecutively transmits the first CIG2 CIS1 signal at an interval of a Sub Interval. The Sub Interval corresponds to 2.5 ms (4 slots).
(2-3-6) The transmitter (Central Device) consecutively transmits the first CIG2 CIS2 signal at an interval of a Sub Interval. The Sub Interval corresponds to 2.5 ms (4 slots).
(3) The receiver (Peripheral Device) receives the signal transmitted from the transmitter, and transmits a response signal thereto to the transmitter.
(3-1) The first earbud (unidirectional Mono Audio) corresponds to the unidirectional Mono Audio. The first earbud (unidirectional Mono Audio) consecutively receives the first ACL1 signal and the first CIG1 CIS1 signal from the transmitter (Central Device) at an interval of a CIS offset. The CIS offset corresponds to 2.5 ms (4 slots).
(3-1-1) The earbud (unidirectional Mono Audio) consecutively receives the first CIG1 CIS1 signal from the transmitter (Central Device) at an interval of an ISO Interval. The ISO Interval corresponds to 10 ms.
(3-1-2) The first earbud (unidirectional Mono Audio) transmits the first ACL2 signal to the transmitter (Central Device) in response to the first ACL1 signal.
(3-1-3) The first earbud (unidirectional Mono Audio) transmits the second CIG1 CIS1 signal to the transmitter (Central Device) in response to the first CIG1 CIS1 signal.
(3-2) The second earbud (unidirectional Mono Audio) corresponds to the unidirectional Mono Audio. The second earbud (unidirectional Mono Audio) consecutively receives the first ACL2 signal and the first CIG1 CIS2 signal from the transmitter (Central Device) at an interval of a CIS offset. The CIS offset corresponds to 2.5 ms (4 slots).
(3-2-1) The second earbud (unidirectional Mono Audio) consecutively receives the first CIG1 CIS2 signal from the transmitter (Central Device) at an interval of an ISO Interval. The ISO Interval corresponds to 10 ms.
(3-2-2) The second earbud (unidirectional Mono Audio) transmits the second ACL2 signal to the transmitter (Central Device) in response to the first ACL2 signal.
(3-2-3) The second earbud (unidirectional Mono Audio) transmits the second CIG1 CIS2 signal to the transmitter (Central Device) in response to the first CIG1 CIS2 signal.
(3-3) The keyboard (ULL HID) corresponds to the ULL HID. The keyboard (ULL HID) consecutively receives the first ACL3 signal and the first CIG2 CIS1 signal from the transmitter (Central Device) at an interval of a CIS offset. The CIS offset corresponds to 3.29 ms.
(3-3-1) The keyboard (ULL HID) consecutively receives the first CIG2 CIS1 signal from the transmitter (Central Device) at an interval of a Sub Interval. The Sub Interval corresponds to 4 slots (2.5 ms).
(3-3-2) The keyboard (ULL HID) transmits the second ACL3 signal to the transmitter (Central Device) in response to the first ACL3 signal.
(3-3-3) The keyboard (ULL HID) transmits the second CIG2 CIS1 signal to the transmitter (Central Device) in response to the first CIG2 CIS1 signal.
(3-4) The mouse (ULL HID) corresponds to the ULL HID. The mouse (ULL HID) consecutively receives the first ACL4 signal and the first CIG2 CIS2 signal from the transmitter (Central Device) at an interval of a CIS offset. The CIS offset corresponds to 3.29 ms.
(3-4-1) The mouse (ULL HID) consecutively receives the first CIG2 CIS2 signal from the transmitter (Central Device) at an interval of a Sub Interval. The Sub Interval corresponds to 4 slots (2.5 ms).
(3-4-2) The mouse (ULL HID) transmits the second ACL4 signal to the transmitter (Central Device) in response to the first ACL4 signal.
(3-4-3) The mouse (ULL HID) transmits the second CIG2 CIS2 signal to the transmitter (Central Device) in response to the first CIG2 CIS2 signal.
(4-1) That is, the transmitter may simultaneously transmit the Audio signal and the ULL HID signal without collision with an offset so that signals do not overlap with each other by setting an offset between the signals.
(4-2) The receiver may receive the Audio signal and the ULL HID signal from the transmitter without any change in the device.

Signal information related to the embodiment of FIG. 19 is as follows.
(1) CIG1 Parameter
(1-1) SDU_Interval_C_To_P=10 ms, SDU_Interval_P_To_C=10 ms
(1-2) Max_Transport_Latency_C_To_P=Depend on reliability
(1-3) CIS1 for Earbud w/o Mic
(1-3-1) Configuration
(1-3-1-1) ISO Interval=10 ms, Sub Interval=2.5 ms
(1-3-1-2) CIS offset=2.5 ms, NSE=3, BN=1, FT=1~4
(1-3-2) Duration: 788 us
(1-3-2-1) Central to Peripheral: 444 us (Payload 100 byte)
(1-3-2-2) Peripheral to Central: 44 us (Empty packet)
(1-3-2-3) T_IFS (150 us)+T_MSS (150 μs): 300 μs
(1-3-3-1) Depend on channel quality
(1-3-3-2) 48 KHz/16 bit Audio
(1-4) CIS2 for Earbud w/o Mic
(1-4-1) Configuration
(1-4-1-1) ISO Interval=10 ms, Sub Interval=2.5 ms
(1-4-1-2) CIS offset=2.5 ms, NSE=3, BN=1, FT=1~4
(1-4-2) Duration: 788 us
(1-4-2-1) Central to Peripheral: 444 us (Payload 100 byte)
(1-4-2-2) Peripheral to Central: 44 us (Empty packet)
(1-4-2-3) T_IFS (150 us)+T_MSS (150 μs): 300 μs
(1-4-3-1) Depend on channel quality
(1-4-3-2) 48 KHz/16 bit Audio
(2) CIG2 Parameter
(2-1) SDU_Interval_C_To_P=2.5 ms, SDU_Interval_P_To_C=2.5 ms
(2-2) Max_Transport_Latency_C_To_P=10 ms
(2-3) CIS1 for Keyboard
(2-3-1) Configuration
(2-3-1-1) ISO Interval=10 ms, Sub Interval=2.5 ms
(2-3-1-2) CIS offset=3.29 ms, NSE=4, BN=4, FT=1
(2-3-2) Duration: 460 us
(2-3-2-1) Central to Peripheral: 44 us (Empty packet)
(2-3-2-2) Peripheral to Central: 116 us (Payload 14 byte)
(2-3-2-3) T_IFS (150 us)+T_MSS (150 μs): 300 μs
(2-4) CIS2 for Mouse
(2-4-1) Configuration
(2-4-1-1) ISO Interval=10 ms, Sub Interval=2.5 ms
(2-4-1-2) CIS offset=3.29 ms, NSE=4, BN=4, FT=1
(2-4-2) Duration: 460 us
(2-4-2-1) Central to Peripheral: 44 us (Empty packet)
(2-4-2-2) Peripheral to Central: 116 us (Payload 14 byte)
(2-4-2-3) T_IFS (150 us)+T_MSS (150 μs): 300 μs

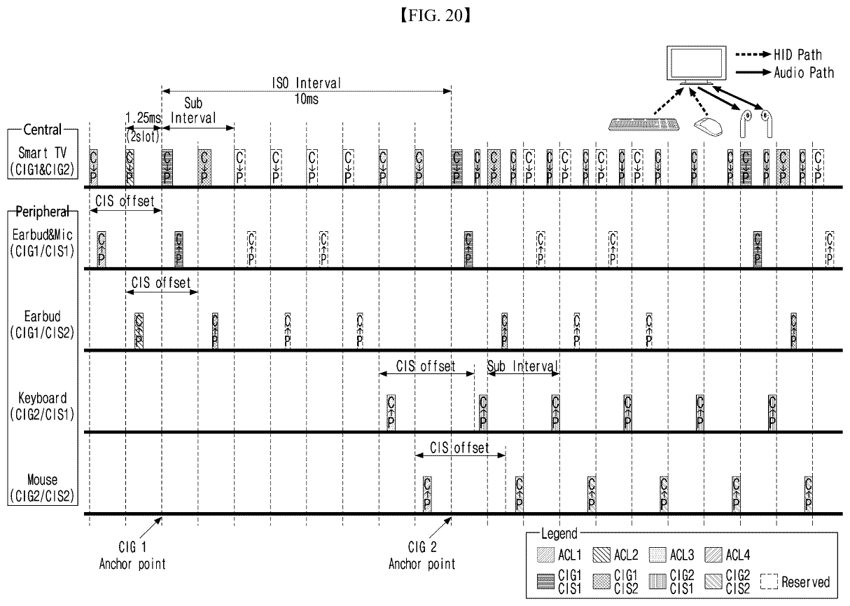

FIG. 20 illustrates an example of a unicast audio and ultra-low latency HID simultaneous transmission technique of the Bluetooth technology in the system of the present disclosure.
(1) An embodiment of FIG. 20 is a case where Unicast Audio and ultra-low latency HID of Bluetooth technology are transmitted at the same time, and may correspond to, for example, a case where an earbud, a keyboard, and a mouse that are enabled to be transmitted and received are used at the same time.
(1-1) Specifically, the embodiment of FIG. 20 corresponds to a technique in which the transmitter simultaneously transmits one bidirectional Mono Audio, one unidirectional Mono Audio, and two ULL HIDs.
(1-2) In the embodiment of FIG. 20, the transmitter separately transmits Audio and HID by CIG.
(1-3) In the embodiment of FIG. 20, the transmitter selects an inter-CIG offset as a multiple of the ISO Interval.
(1-4) In the embodiment of FIG. 20, the transmitter leaves a last interval of Audio transmission empty for the ACL.
(1-5) In the embodiment of FIG. 20, the transmitter (Central Device) may correspond to a smart TV. The receiver (Peripheral Device) may correspond to an earbud & microphone (bidirectional Mono Audio), the earbud (unidirectional Mono Audio), the keyboard (ULL HID), and the mouse (ULL HID).
(2) The transmitter (Central Device) transmits and receives signals to and from a plurality of receivers (Peripheral Devices).
(2-1) Signals transmitted and received between the transmitter (Central Device) and the plurality of receivers (Peripheral Devices) include a first signal transmitted from the Central device to the Peripheral device and a second signal received from the Peripheral device to the Central device.
(2-2) The transmitter (Central Device) sets an offset to the Audio signal and the HID signal so as to transmit the signals so as not to overlap with each other, so that various receivers may receive signals corresponding to themselves without any problem.
(2-3) The transmitter (Central Device) consecutively transmits a first ACL1 signal, a first ACL2 signal, a first first CIG1 CIS1 signal, and a first first CIG1 CIS2 signal at an interval of 2 slots (1.25 ms). Thereafter, the transmitter (Central Device) empties 8 slots (5 ms) and does not perform transmission.
(2-3-1) A time point at which a first transmission of a first CIG1 CIS2 signal starts corresponds to a CIG1 anchor point. A time point after 10 ms (ISO Interval) from the CIG1 anchor point corresponds to a CIG2 anchor point.
(2-3-2) After 12 slots from the CIG1 anchor point, the transmitter (Central Device) consecutively transmits the first ACL3 signal and the first ACL4 signal at an interval of 2 slots.
(2-3-3) From the CIG2 anchor point, the transmitter (Central Device) consecutively transmits a second first CIG1 CIS1 signal and a second first CIG1 CIS2 signal at an interval of 2 slots. From the CIG2 anchor point, the transmitter (Central Device) repeats transmission of the first CIG1 CIS1 signal and transmission of the CIG1 CIS2 signal at an interval of 10 ms (ISO Interval).
(2-3-4) After 1 slot from the CIG2 anchor point, the transmitter (Central Device) alternately repeats the transmission of the first CIG2 CIS1 signal and the transmission of the first CIG2 CIS2 signal at an interval of 2 slots.
(2-3-5) The transmitter (Central Device) consecutively transmits the first CIG2 CIS1 signal at an interval of a Sub Interval. The Sub Interval corresponds to 2.5 ms (4 slots).
(2-3-6) The transmitter (Central Device) consecutively transmits the first CIG2 CIS2 signal at an interval of a Sub Interval. The Sub Interval corresponds to 2.5 ms (4 slots).
(3) The receiver (Peripheral Device) receives the signal transmitted from the transmitter, and transmits a response signal thereto to the transmitter.
(3-1) Earbud & microphone (bidirectional Mono Audio) corresponds to bidirectional Mono Audio. The earbud & microphone (bidirectional Mono Audio) consecutively receives a first ACL1 signal and a first CIG1 CIS1 signal from the transmitter (Central Device) at an interval of a CIS offset. The CIS offset corresponds to 2.5 ms (4 slots).
(3-1-1) The earbud & microphone (bidirectional Mono Audio) consecutively receives the first CIG1 CIS1 signal from the transmitter (Central Device) at an interval of an ISO Interval. The ISO Interval corresponds to 10 ms.
(3-1-2) The earbud & microphone (bidirectional Mono Audio) transmits a second ACL1 signal to the transmitter (Central Device) in response to the first ACL1 signal.
(3-1-3) The earbud & microphone (bidirectional Mono Audio) transmits a second CIG1 CIS1 signal to the transmitter (Central Device) in response to the first CIG1 CIS1 signal.
(3-2) The earbud & microphone (unidirectional Mono Audio) corresponds to the unidirectional Mono Audio. The earbud & microphone (unidirectional Mono Audio) consecutively receives a first ACL2 signal and the first CIG1 CIS1 signal from the transmitter (Central Device) at the interval of the CIS offset. The CIS offset corresponds to 2.5 ms (4 slots).
(3-2-1) The earbud (unidirectional Mono Audio) consecutively receives the first CIG1 CIS2 signal from the transmitter (Central Device) at an interval of an ISO Interval. The ISO Interval corresponds to 10 ms.
(3-2-2) The earbud (unidirectional Mono Audio) transmits a second ACL2 signal to the transmitter (Central Device) in response to the first ACL2 signal.
(3-2-3) The earbud (unidirectional Mono Audio) transmits a second CIG1 CIS2 signal to the transmitter (Central Device) in response to the first CIG1 CIS2 signal.
(3-3) The keyboard (ULL HID) corresponds to the ULL HID. The keyboard (ULL HID) consecutively receives the first ACL3 signal and the first CIG2 CIS1 signal from the transmitter (Central Device) at an interval of a CIS offset. The CIS offset corresponds to 3.29 ms.
(3-3-1) The keyboard (ULL HID) consecutively receives the first CIG2 CIS1 signal from the transmitter (Central Device) at an interval of a Sub Interval. The Sub Interval corresponds to 4 slots (2.5 ms).
(3-3-2) The keyboard (ULL HID) transmits the second ACL3 signal to the transmitter (Central Device) in response to the first ACL3 signal.
(3-3-3) The keyboard (ULL HID) transmits the second CIG2 CIS1 signal to the transmitter (Central Device) in response to the first CIG2 CIS1 signal.
(3-4) The mouse (ULL HID) corresponds to the ULL HID. The mouse (ULL HID) consecutively receives the first ACL4 signal and the first CIG2 CIS2 signal from the transmitter (Central Device) at an interval of a CIS offset. The CIS offset corresponds to 3.29 ms.
(3-4-1) The mouse (ULL HID) consecutively receives the first CIG2 CIS2 signal from the transmitter (Central Device) at an interval of a Sub Interval. The Sub Interval corresponds to 4 slots (2.5 ms).
(3-4-2) The mouse (ULL HID) transmits a second ACL4 signal to the transmitter (Central Device) in response to the first ACL4 signal.
(3-4-3) The mouse (ULL HID) transmits the second CIG2 CIS2 signal to the transmitter (Central Device) in response to the first CIG2 CIS2 signal.
(4-1) That is, the transmitter may simultaneously transmit the Audio signal and the ULL HID signal without collision with an offset so that signals do not overlap with each other by setting an offset between the signals.
(4-2) The receiver may receive the Audio signal and the ULL HID signal from the transmitter without any change in the device.

Signal information related to the embodiment of FIG. 20 is as follows.
(1) CIG1 Parameter
(1-1) SDU_Interval_C_To_P=10 ms, SDU_Interval_P_To_C=10 ms
(1-2) Max_Transport_Latency_C_To_P=Depend on reliability
(1-3) CIS1 for Earbud w/Mic
(1-3-1) Configuration
(1-3-1-1) ISO Interval=10 ms, Sub Interval=2.5 ms
(1-3-1-2) CIS offset=2.5 ms, NSE=3, BN=1, FT=1~4
(1-3-2) Duration: 788 us
(1-3-2-1) Central to Peripheral: 284 us (Payload 60 byte)
(1-3-2-2) Peripheral to Central: 204 us (Payload 40 byte)
(1-3-2-3) T_IFS (150 us)+T_MSS (150 μs): 300 μs
(1-3-3-1) Depend on channel quality
(1-3-3-2) 16 kHz/16 bit Audio
(1-4) CIS2 for Earbud w/o Mic
(1-4-1) Configuration
(1-4-1-1) ISO Interval=10 ms, Sub Interval=2.5 ms
(1-4-1-2) CIS offset=2.5 ms, NSE=3, BN=1, FT=1~4
(1-4-2) Duration: 628 us
(1-4-2-1) Central to Peripheral: 284 us (Payload 60 byte)
(1-4-2-2) Peripheral to Central: 44 us (Empty packet)
(1-4-2-3) T_IFS (150 us)+T_MSS (150 μs): 300 μs
(1-4-3-1) Depend on channel quality
(1-4-3-2) 24 kHz/16 bit Audio
(2) CIG2 Parameter
(2-1) SDU_Interval_C_To_P=5 ms, SDU_Interval_P_To_C=5 ms
(2-2) Max_Transport_Latency_C_To_P=10 ms
(2-3) CIS1 for Keyboard
(2-3-1) Configuration
(2-3-1-1) ISO Interval=10 ms, Sub Interval=2.5 ms
(2-3-1-2) CIS offset=3.29 ms, NSE=4, BN=4, FT=1
(2-3-2) Duration: 460 us
(2-3-2-1) Central to Peripheral: 44 us (Empty packet)
(2-3-2-2) Peripheral to Central: 116 us (Payload 14 byte)
(2-3-2-3) T_IFS (150 us)+T_MSS (150 μs): 300 μs
(2-4) CIS2 for Mouse
(2-4-1) Configuration
(2-4-1-1) ISO Interval=10 ms, Sub Interval=2.5 ms
(2-4-1-2) CIS offset=3.29 ms, NSE=4, BN=4, FT=1
(2-4-2) Duration: 460 us
(2-4-2-1) Central to Peripheral: 44 us (Empty packet)
(2-4-2-2) Peripheral to Central: 120 us (Payload 14 byte)
(2-4-2-3) T_IFS (150 us)+T_MSS (150 μs): 300 μs

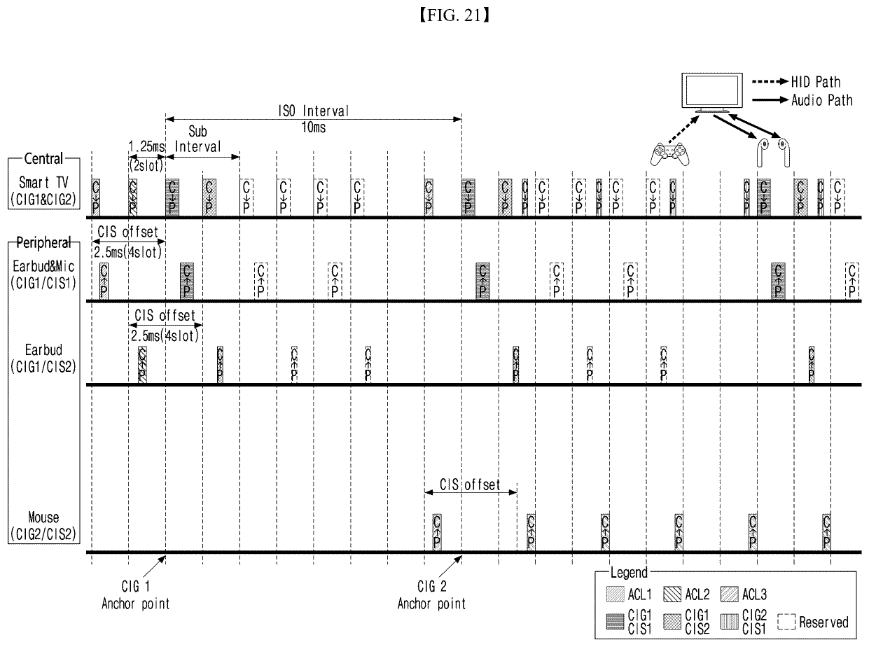

FIG. 21 illustrates an example of a unicast audio and ultra-low latency HID simultaneous transmission technique of the Bluetooth technology in the system of the present disclosure.
(1) An embodiment of FIG. 21 is a case where Unicast Audio and ultra-low latency HID of Bluetooth technology are transmitted at the same time, and may correspond to, for example, a case where an earbud and a game pad that are enabled to be transmitted and received are used at the same time.
(1-1) Specifically, the embodiment of FIG. 21 corresponds to a technique in which the transmitter simultaneously transmits one bidirectional Mono Audio, one unidirectional Mono Audio, and one ULL HID.
(1-2) In the embodiment of FIG. 21, the transmitter separately transmits Audio and HID by CIG.
(1-3) In the embodiment of FIG. 21, the transmitter selects an inter-CIG offset as a multiple of the ISO Interval.
(1-4) In the embodiment of FIG. 21, the transmitter leaves a last interval of Audio transmission empty for the ACL.
(1-5) In the embodiment of FIG. 21, the transmitter (Central Device) may correspond to a smart TV. The receiver (Peripheral Device) may correspond to an earbud & microphone (bidirectional Mono Audio), the earbud (unidirectional Mono Audio), and the game pad (ULL HID).
(2) The transmitter (Central Device) transmits and receives signals to and from a plurality of receivers (Peripheral Devices).
(2-1) Signals transmitted and received between the transmitter (Central Device) and the plurality of receivers (Peripheral Devices) include a first signal transmitted from the Central device to the Peripheral device and a second signal received from the Peripheral device to the Central device.
(2-2) The transmitter (Central Device) sets an offset to the Audio signal and the HID signal so as to transmit the signals so as not to overlap with each other, so that various receivers may receive signals corresponding to themselves without any problem.
(2-3) The transmitter (Central Device) consecutively transmits a first ACL1 signal, a first ACL2 signal, a first first CIG1 CIS1 signal, and a first first CIG1 CIS2 signal at an interval of 2 slots (1.25 ms). Thereafter, the transmitter (Central Device) empties 10 slots (6.25 ms) and does not perform transmission.
(2-3-1) A time point at which a first transmission of a first CIG1 CIS2 signal starts corresponds to a CIG1 anchor point. A time point after 10 ms (ISO Interval) from the CIG1 anchor point corresponds to a CIG2 anchor point.
(2-3-2) After 14 slots from the CIG1 anchor point, the transmitter (Central Device) consecutively transmits the first ACL3 signal.
(2-3-3) From the CIG2 anchor point, the transmitter (Central Device) consecutively transmits a second first CIG1 CIS1 signal and a second first CIG1 CIS2 signal at an interval of 2 slots. From the CIG2 anchor point, the transmitter (Central Device) repeats transmission of the first CIG1 CIS1 signal and transmission of the CIG1 CIS2 signal at an interval of 10 ms (ISO Interval).
(2-3-4) After 3 slots from the CIG2 anchor point, the transmitter (Central Device) repeats the transmission of the first CIG2 CIS1 signal at an interval of 4 slots.
(2-3-5) The transmitter (Central Device) consecutively transmits the first CIG2 CIS1 signal at an interval of a Sub Interval. The Sub Interval corresponds to 2.5 ms (4 slots).
(3) The receiver (Peripheral Device) receives the signal transmitted from the transmitter, and transmits a response signal thereto to the transmitter.
(3-1) Earbud & microphone (bidirectional Mono Audio) corresponds to bidirectional Mono Audio. The earbud & microphone (bidirectional Mono Audio) consecutively receives a first ACL1 signal and a first CIG1 CIS1 signal from the transmitter (Central Device) at an interval of a CIS offset. The CIS offset corresponds to 2.5 ms (4 slots).
(3-1-1) The earbud & microphone (bidirectional Mono Audio) consecutively receives the first CIG1 CIS1 signal from the transmitter (Central Device) at an interval of an ISO Interval. The ISO Interval corresponds to 10 ms.
(3-1-2) The earbud & microphone (bidirectional Mono Audio) transmits a second ACL1 signal to the transmitter (Central Device) in response to the first ACL1 signal.
(3-1-3) The earbud & microphone (bidirectional Mono Audio) transmits a second CIG1 CIS1 signal to the transmitter (Central Device) in response to the first CIG1 CIS1 signal.
(3-2) The earbud & microphone (unidirectional Mono Audio) corresponds to the unidirectional Mono Audio. The earbud & microphone (unidirectional Mono Audio) consecutively receives a first ACL2 signal and the first CIG1 CIS1 signal from the transmitter (Central Device) at an interval of a CIS offset. The CIS offset corresponds to 2.5 ms (4 slots).
(3-2-1) The earbud (unidirectional Mono Audio) consecutively receives the first CIG1 CIS2 signal from the transmitter (Central Device) at an interval of an ISO Interval. The ISO Interval corresponds to 10 ms.
(3-2-2) The earbud (unidirectional Mono Audio) transmits a second ACL2 signal to the transmitter (Central Device) in response to the first ACL2 signal.
(3-2-3) The earbud (unidirectional Mono Audio) transmits a second CIG1 CIS2 signal to the transmitter (Central Device) in response to the first CIG1 CIS2 signal.
(3-3) The game pad (ULL HID) corresponds to the ULL HID. The keyboard (ULL HID) consecutively receives the first ACL3 signal and the first CIG2 CIS1 signal from the transmitter (Central Device) at an interval of a CIS offset. The CIS offset corresponds to 3.29 ms.
(3-3-1) The game pad (ULL HID) consecutively receives the first CIG2 CIS1 signal from the transmitter (Central Device) at an interval of a Sub Interval. The Sub Interval corresponds to 4 slots (2.5 ms).
(3-3-2) The game pad (ULL HID) transmits the second ACL3 signal to the transmitter (Central Device) in response to the first ACL3 signal.
(3-3-3) The game pad (ULL HID) transmits the second CIG2 CIS1 signal to the transmitter (Central Device) in response to the first CIG2 CIS1 signal.
(4-1) That is, the transmitter may simultaneously transmit the Audio signal and the ULL HID signal without collision with an offset so that signals do not overlap with each other by setting an offset between the signals.
(4-2) The receiver may receive the Audio signal and the ULL HID signal from the transmitter without any change in the device.

Signal information related to the embodiment of FIG. 21 is as follows.
(1) CIG1 Parameter
(1-1) SDU_Interval_C_To_P=10 ms, SDU_Interval_P_To_C=10 ms
(1-2) Max_Transport_Latency_C_To_P=Depend on reliability
(1-3) CIS1 for Earbud w/Mic
(1-3-1) Configuration
(1-3-1-1) ISO Interval=10 ms, Sub Interval=2.5 ms
(1-3-1-2) CIS offset=2.5 ms, NSE=3, BN=1, FT=1~4
(1-3-2) Duration: 1108 us
(1-3-2-1) Central to Peripheral: 444 us (Payload 100 byte)
(1-3-2-2) Peripheral to Central: 364 us (Payload 80 byte)
(1-3-2-3) T_IFS (150 us)+T_MSS (150 μs): 300 μs
(1-3-3-1) 48 KHz/16 bit Audio
(1-3-3-2) 32 kHz/16 bit Audio
(1-4) CIS2 for Earbud w/o Mic
(1-4-1) Configuration
(1-4-1-1) ISO Interval=10 ms, Sub Interval=2.5 ms
(1-4-1-2) CIS offset=2.5 ms, NSE=3, BN=1, FT=1~4
(1-4-2) Duration: 788 us
(1-4-2-1) Central to Peripheral: 444 us (Payload 100 byte)
(1-4-2-2) Peripheral to Central: 44 us (Empty packet)
(1-4-2-3) T_IFS (150 us)+T_MSS (150 μs): 300 μs
(1-4-3-1) Depend on channel quality
(1-4-3-2) 48 KHz/16 bit Audio
(2) CIG2 Parameter
(2-1) SDU_Interval_C_To_P=2.5 ms, SDU_Interval_P_To_C=2.5 ms
(2-2) Max_Transport_Latency_C_To_P=10 ms
(2-3) CIS1 for Gamepad
(2-3-1) Configuration
(2-3-1-1) ISO Interval=10 ms, Sub Interval=2.5 ms
(2-3-1-2) CIS offset=3.29 ms, NSE=4, BN=4, FT=1
(2-3-2) Duration: 460 us
(2-3-2-1) Central to Peripheral: 44 us (Empty packet)
(2-3-2-2) Peripheral to Central: 116 us (Payload 14 byte)
(2-3-2-3) T_IFS (150 us)+T_MSS (150 μs): 300 μs

### [Description Related to Host Device Claim]

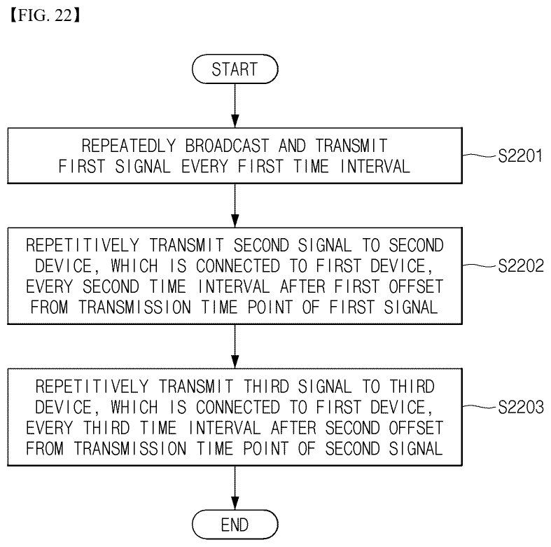

Hereinafter, the above-described embodiments will be described in detail with reference to FIG. 22 in terms of the operation of a UE. Methods to be described below are just distinguished for convenience and unless the methods mutually exclusive, it is needless to say that some components of any one method may be substituted with some components of another method or may be applied in combination with each other.

FIG. 22 illustrates an example of an operation process of a wireless device in a short-range wireless communication system according to various embodiments of the present disclosure.

According to various embodiments of the present disclosure, a method performed by a wireless device (i.e., a first device) in a short-range wireless communication system is provided.

The first device includes: a first processor corresponding to a host stack; a second processor corresponding to a controller stack; a memory; an input device corresponding to a user interface (UI); an output device corresponding to the UI; and a transceiver. The host stack and the controller stack are connected by a Host Controller Interface (HCI).

In step S2201, the first device repeatedly broadcasts and transmits a first signal every first time interval.

In step S2202, the first device repetitively transmits a second signal to a second device, which is connected to the first device, every second time interval after a first offset from a transmission time point of the first signal.

In step S2203, the first device repetitively transmits a third signal to a third device, which is connected to the first device, every third time interval after a second offset from a transmission time point of the second signal.

The first signal, the second signal, and the third signal are not simultaneously transmitted.

According to various embodiments of the present disclosure, the first signal may be an Asynchronous Connection-oriented Logical Transport (ACL) signal, the second signal may be a Bluetooth based unicast audio signal, the third signal may be an ultra-low latency Human Interface Device (ULL HID) signal, and the second device may be a Bluetooth based audio device, and the third device may be an ultra-low latency HID device.

According to various embodiments of the present disclosure, the second signal and the third signal may be separately transmitted as a Connected Isochronous Group (CIG) and a Connecting Isochronous Stream (CIS), and the second time interval may correspond to an isochronous (ISO) interval.

According to various embodiments of the present disclosure, transmission of the second signal during the second time interval after transmission of the second signals may be emptied for repeated transmission of the first signal.

According to various embodiments of the present disclosure, the second time interval may correspond to a value that is not a multiple of the third time interval.

According to various embodiments of the present disclosure, when the transmission of the second signal and the transmission of the third signal are scheduled at the same time, only one of the second signal and the third signal may be transmitted.

According to various embodiments of the present disclosure, when the transmission of the second signal and the transmission of the third signal are scheduled at the same time, only one corresponding to a set priority between the second signal and the third signal may be transmitted.

According to various embodiments of the present disclosure, a wireless device is provided in a short-range wireless communication system. The wireless device includes: a first processor corresponding to a host stack; a second processor corresponding to a controller stack; a memory; an input device corresponding to a user interface (UI); an output device corresponding to the UI; and a transceiver. The host stack and the controller stack are connected by a Host Controller Interface (HCI). The memory may be configured to store instructions for performing the operation method of the first device according to FIG. 22 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the first device according to FIG. 22 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the first device according to FIG. 22.

Claims set forth in various embodiments of the present disclosure may be combined in various schemes. For example, technical features of method claims of various embodiments of the present disclosure may be combined and implemented as a device, and technical features of device claims of various embodiments of the present disclosure may be combined and implemented as a method. Further, the technical features of the method claims and the technical features of the device claims of various embodiments of the present disclosure may be combined and implemented as the device, and the technical features of the method claims and the technical features of the device claims of various embodiments of the present disclosure may be combined and implemented as the method.

1. An operation method of a first device in a short-range wireless communication system, wherein the first device includes: a first processor corresponding to a host stack; a second processor corresponding to a controller stack; a memory; an input device corresponding to a user interface (UI); an output device corresponding to the UI; and a transceiver, wherein the host stack and the control stack are connected via a host controller interface (HCI), the operation method comprising:
repetitively broadcasting a first signal every first time interval;
repetitively transmitting a second signal to a second device, which is connected to the first device, every second time interval after a first offset from the transmission time of the first signal; and
repetitively transmitting a third signal to a third device, which is connected to the first device, every third time interval after a second offset from the transmission time of the second signal, and
wherein the first signal, the second signal, and the third signal are not simultaneously transmitted.

2. The method of claim 1, wherein the first signal is an Asynchronous Connection-oriented Logical Transport (ACL) signal,
wherein the second signal is a Bluetooth-based unicast audio signal,
wherein the third signal is an Ultra Low Latency Human Interface Device (ULL HID) signal,
wherein the second device is a Bluetooth-based audio device, and
wherein the third apparatus is an ultra-low latency HID device.

3. The method of claim 1, wherein the second signal and the third signal are separately transmitted in a Connected Isochronous Group (CIG) and a Connecting Isochronous Stream (CIS), and
the second time interval corresponds to an isochronous interval (ISO) interval.

4. The method of claim 3, wherein transmission of the second signal during the second time interval after transmission of the second signals is emptied for repeated transmission of the first signal.

5. The method of claim 1, wherein the second time interval corresponds to a value that is not a multiple of the third time interval.

6. The method of claim 1, wherein when the transmission of the second signal and the transmission of the third signal are scheduled at the same time, only one of the second signal and the third signal is transmitted.

7. The method of claim 1, wherein when the transmission of the second signal and the transmission of the third signal are scheduled at the same time, only one signal corresponding to a set priority among the second signal and the third signal is transmitted.

8. A first device in a short-range wireless communication system, the first device comprising:
a first processor corresponding to a host stack;
a second processor corresponding to a controller stack;
a memory;
an input device corresponding to a user interface (UI);
an output device corresponding to the UI; and
a transceiver,
wherein the host stack and the controller stack are connected by a Host Controller Interface (HCI),
wherein the memory stores instructions of performing operations based on being executed by the first processor and the second processor,
wherein in an operation method of a first device in a short-range wireless communication system, the first device includes: a first processor corresponding to a host stack; a second processor corresponding to a controller stack; a memory; an input device corresponding to a user interface (UI); an output device corresponding to the UI; and a transceiver, wherein the host stack and the control stack are connected via a host controller interface (HCI), and the operations include
repetitively broadcasting a first signal every first time interval;
repetitively transmitting a second signal to a second device, which is connected to the first device, every second time interval after a first offset from the transmission time of the first signal; and
repetitively transmitting a third signal to a third device, which is connected to the first device, every third time interval after a second offset from the transmission time of the second signal, and
wherein the first signal, the second signal, and the third signal are not simultaneously transmitted.

9. The first device of claim 8, wherein the first signal is an Asynchronous Connection-oriented Logical Transport (ACL) signal,
wherein the second signal is a Bluetooth-based unicast audio signal,
wherein the third signal is an Ultra Low Latency Human Interface Device (ULL HID) signal,
wherein the second device is a Bluetooth-based audio device, and
wherein the third apparatus is an ultra-low latency HID device.

10. The first device of claim 8, wherein the second signal and the third signal are separately transmitted in a Connected Isochronous Group (CIG) and a Connecting Isochronous Stream (CIS), and
wherein the second time interval corresponds to an isochronous interval (ISO) interval.

11. The first device of claim 10, wherein transmission of the second signal during the second time interval after transmission of the second signals is emptied for repeated transmission of the first signal.

12. The first device of claim 8, wherein the second time interval corresponds to a value that is not a multiple of the third time interval.

13. The first device of claim 8, wherein when the transmission of the second signal and the transmission of the third signal are scheduled at the same time, only one of the second signal and the third signal is transmitted.

14. The first device of claim 8, wherein when the transmission of the second signal and the transmission of the third signal are scheduled at the same time, only one signal corresponding to a set priority among the second signal and the third signal is transmitted.
